(19) United States
(12) Patent Application Publication
(10) Pub. No.: US 2009/0302065 A1
(43) Pub. Date: Dec. 10, 2009

(54) SYSTEM AND DEVICE FOR UNLOADING BULK MATERIALS FROM A HOPPER

(75) Inventor: Robert B. Winsor, Montreal (CA)

Correspondence Address: Kregg T. Brooks;ICE MILLER LLP, Suite 3500, 200 West Madison Street, Chicago, IL, 60606, US

(73) Assignee: HOLDEN INTERNATIONAL INC., St. Michael (BB)

(21) Appl. No.: 12/478,973

(22) Filed: Jun. 5, 2009

Related U.S. Application Data
(60) Provisional application No. 61/131,202, filed on Jun. 6, 2008.

(51) Int. Cl. G01F 11/20

(52) U.S. Cl. 222/236; 222/410; 222/561

(57) ABSTRACT

This application discloses a device for urging bulk material to flow from a hopper such as the hopper of a railway car. The device includes a rotating axle that can be rotated by a power wrench, and one or more rotating agitators having auger coils disposed near the bottom outlet of a hopper and which are rotatably connected to the axle. Rotating the axle causes the agitators to rotate, thereby breaking up and urging bulk material to flow downward through the bottom outlet. Also disclosed is a system for emptying a hopper such as the hopper of a railway car, wherein a device with rotatable agitators having auger coils is integrated with a sliding gate assembly situated at the bottom outlet of the hopper. A power wrench can be used both to open and close the gate assembly, and to rotate the agitators in the hopper so as to break up and urge bulk material downward and out of the hopper through the opened gate assembly.

This application claims priority from provisional U.S. Patent Application Ser. No. 61/131,202, filed Jun. 6, 2008, which is hereby incorporated by reference.

### BACKGROUND

Hopper rail cars, both open and closed, are used to transport loose bulk material such as coal, ore, grain, track ballast, and the like. Recently, with the advent of the biofuels industry, hopper cars have been employed to transport distiller's dry grains, which is a byproduct of corn ethanol production. Distiller's dry grains (“DDG”) is the leftover material remaining after the conversion of corn sugars to ethanol. This material may be processed and made useful, for example, as an animal feed additive. Because of the increase in corn ethanol production, the production of DDG has vastly increased, and is predicted to increase greatly in the future.

As shown in FIG. 1, a gravity discharge hopper car 100 is typically composed of three or four hoppers 101. These hoppers each have side walls 108 and a lower portion 109 comprising four slope sheets 102, sloping towards each other to form an upside-down truncated 4-sided pyramid. There are also normally vertical cross-car walls 107 extending above the apex where the slope-sheets of adjacent hoppers meet, thus extending the separation between hoppers 101 higher than the slope sheets 102. The intersection of the slope sheets 102 further define four sloping valleys 103. The four slope sheets 102 of each hopper 101 are truncated short of their apex to form a rectangular bottom outlet 104, which can be opened or closed using a gate, typically a sliding gate assembly 105. Typically, the bottom outlet 104 will have disposed around it an outlet flange 104a to which the sliding gate assembly 105 may be secured. In normal operation, the gate assembly 105 is closed during filling of the hoppers 101 and opened in order to empty the hoppers 101. Such cars 100 can thus be emptied by opening the sliding gate assembly 105 to allow the bulk material to exit the hopper 101 into a vessel located below the rail track. If the material to be transported carried by the rail car is expected to flow under the force of gravity alone, such gate assemblies are termed “gravity discharge gates.”

While a hopper rail car that is designed for and equipped with gravity discharge gates is very useful for economically transporting bulk materials, certain common bulk materials present challenges. DDG is such a material, as it is a granular bulk material having a tendency to clump and aggregate, particularly when it has a substantial moisture content. DDG will generally have a substantial moisture content unless it is subject to an extensive and prohibitively expensive drying process. Other materials, such as soya meal, corn gluten, mulch, peat, and topsoil, also present special challenges during the unloading operations from gravity discharge hopper cars. Even mineral materials such as sand and powdered ores may present similar challenges during unloading operations under certain conditions.

Typically, one or both of two major problems arise in unloading bulk commodities such as DDG from any hopper. As shown in FIG. 2, when the bottom outlet 104 of a hopper 101 is opened to unload a bulk material 201 following transit, because of settling, the bulk commodities can, under a number of conditions, form a bridge or arch-shaped plug 202 that effectively prevents the flow of material 201 out through the hopper's bottom outlet 104. Such conditions include the slope angle, the coefficient of friction between the bulk commodity and the slope sheet surface, the nature of the granular structure of the bulk material, the moisture content in the mix, and the temperature, particularly if the temperature is low enough to result in freezing between the granules of the bulk material. When an arch or bridge plug forms, it requires agitation of some sort to dislodge this plug 202 so that the material may flow freely through the bottom outlet 104. Another problem that arises in bin flow, as shown in FIG. 3, is the formation of “pipes” or “ratholes” in the stored bulk material as the hopper 101 is emptied; that is, as the hopper 101 empties partially in the space 301 directly above the bottom outlet 104, most of the bulk material 201 remains stuck to the slope sheets 102 and builds up above the slope sheets 102 in the straight-sided portion of the hopper 101.

Generally, it would be preferable to design hoppers such as to be cylindrical, or at least to have their lower section designed as an inverted truncated cone rather than an inverted truncated 4-sided pyramid. This is because the sloping valley 103 formed at the juncture of any two adjacent slope sheets 102 is inclined an angle considerably shallower than that of the slope sheets 102. However, the economics of hopper car geometry unfortunately require that the shapes of the lower portions 101a of a hopper bin be far from optimal from the perspective of bin flow. First, the four-sided pyramidal bottom outlet maximizes the volume of the hopper car 100, which has restricted maximum dimensions. Second, the carried volume of each hopper bin 101 is increased if the angles of the slope sheets 102 themselves are as low as possible. The resulting geometry of economical hopper cars intended for light materials such as DDG is poor from the perspective of the facilitation of discharge flow, and as a result, serious difficulties exist in unloading these cars.

Further complicating unloading operations from a hopper car 100 is the overall design of many hopper cars in current use. Some of these cars are based on a “center-flow” design as shown in FIG. 1A, whereby two side sills 106 running the length of the rail car 100 are disposed along the sides of the hoppers 101 to provide structural strength to the car 100, resulting in an obstructed flow path from the top of the hopper through to the bottom opening. However, for some very large cube cars such as certain of those that are most economically employed to carry light, low value materials such as DDG, a “through-sill” design is incorporated, as shown in FIGS. 4 and 4A, wherein a center sill 401, the backbone of the car, runs the length of the car 100, directly through the center of the hoppers 101 to provide the required structural support to the car. This “through-sill” design geometry is such that the bottom of the center sill must be very low and close to the bottom outlet, and being situated directly over the bottom outlet 104 adds an additional obstacle to material flow, compounding the problems caused by the low angle sloping valleys 103 of the slope sheets 102.

In the past, these problems have been addressed in a number of ways. The most common method is to attach the slope sheets 102 of the hopper car 100 to a vibrator, and then shake the hopper car in order to loosen the bulk material and keep it somewhat fluidized as it flows. All gravity discharge hopper cars are equipped with mounting seats on the outside surfaces of the slope sheets 102 for ready attachments of such vibrators. Also, the interior surface of each hopper may be coated with low-friction material to assist the flow characteristics of the hopper. A further method is to design hopper cars with larger bottom outlets requiring very large gate assemblies. This method increases the area that must be bridged in order to cause an arch or bridge plug seen in FIG. 2. Unfortunately, this method is insufficient to facilitate flow in the case of the most difficult materials such as DDG. As a result, heavy sledgehammers are often used on the sides of hopper cars in an attempt to increase the effectiveness of the normal vibrators, resulting in severe damage to the car bodies.

Some purchasers of large quantities of DDG have installed overhead gantries carrying large “digger” type equipment on crawler tracks, this “digger” equipment including long, pointed dagger-like devices that are inserted through the top loading hatches of the hopper cars to dig down through the bulk material load and disturb it sufficiently so as to make the bulk materials flow. This is a costly solution and not wholly effective in itself, and also results in damage to the sides and slope sheets of the hopper cars.

### SUMMARY

A device for assisting bulk materials to flow from a hopper having a bottom outlet is presented. The device has a rotating axle, and one or more rotating agitators rotatably connected to the axle. The agitators are disposed near the bottom outlet and are rotated by rotating the axle. The rotating agitators break up and urge bulk materials in the hopper to flow downward and out of the hopper through the bottom outlet. The agitators may have an axis of rotation that is different from that of the axle.

The axle may be horizontal, and may have an end-mounted coupling that can be attached to a drive bit of a power wrench, so that the power wrench may drive the rotation of the axle. The coupling may allow the power wrench to drive the rotation of the axle in only one desired direction. In a specific embodiment, a coupling that allows the axle to be rotated only in one desired direction by a four-cornered drive bit may comprise an inner wheel attached to one end of the axle, an outer wheel attached to the inner wheel by four posts that extend between the wheels, and four spring-biased rotation stops mounted on and rotatable around the posts, and an access corridor comprising a circular opening in each of the wheels that is capable of accommodating the drive bit. In this embodiment of the coupling, the posts are arranged at ninety degrees to one another on the perimeter of the access corridor, and the rotation stops are arranged so that the rotation stops are displaced from engagement with the drive bit when the drive bit is rotated in the direction opposite the desired direction, so that the drive bit rotates freely but does not rotate the coupling and axle. When the drive bit is inserted into the access corridor and rotated in the desired direction, the corners of the drive bit engage the rotation stops, which are spring-biased to be in a position to so engage, and the rotation stops restrain the drive from rotating freely unless the coupling also rotates in the desired direction.

In a further embodiment, a second coupling may be situated at the second end of the axle in such a manner that the coupling may be rotated in a direction opposite the desired direction of the first coupling.

An embodiment of this device may have an axle integrating an axle gear, and a agitator gear enmeshed with the axle gear that can be rotatably coupled with the agitators, such that the one or more agitators is connected to the axle by a connection comprising the axle gear and agitator gear. The connection may comprise a central socket rotatably connected to the agitator gear, and a rotating member that drives the rotation of the agitators may be disposed in the central socket. In one more specific embodiment, the device has but one agitator, and the rotating member is directly attached to the agitators, so that the agitator rotates in the same axis as the agitator gear. Alternatively, the device may have two or more agitators, and the connection further comprises a central gear rotatably attached to the rotating member, and two or more peripheral gears enmeshed with the central gear, each peripheral gear rotatably coupled with an agitator.

In an embodiment having one agitator, the agitator may comprise a rotating member having two or more hubs, on which hubs are attached one or more spiral arms. The hubs may be separately mounted on the rotating member through a torque limiter, such as a ball detent torque limiter, so that the hubs may rotate independent of one another. The hubs may be vertically separated along the rotating member, and each hub may have spiral arms of differing length.

In another embodiment, each of the one or more agitators may have an axis of rotation approximately parallel with a sloping valley of the hopper. An agitator in the embodiment may comprise a helical coil disposed along a sloping valley of the hopper.

In another embodiment, each agitator in such a device may comprise a rod rotatably coupled to the axle by a connection comprising a proximal universal joint. The agitator may further comprise a helical coil having two ends, where one end of the helical coil is connected to an end of the rod by a distal universal joint.

In a related embodiment, the distal universal joint, may be attached to a rotating member on which is disposed two or more hubs, each of which has disposed a helical coil. The hubs may be attached to the rotating member through a torque limiter, such as a ball detent torque limiter. The torque limiter may be adjustable to allow each of the hubs to rotate independently with a different torque release value, and each hub may have a helical coil having a differing helical diameter.

In another embodiment, the device of this invention may have one or more agitators that each comprise a helical coil having two ends, and a mounting rotatably connected to the axle. The mounting secures the coil at a first end of the coil and allows the coil to rotate with the mounting. The coil may extend helically from its first end to its second end and have a helical axis aligned with the axis of rotation of the mounting. In more specific embodiments, the coil may have a conical, cylindrical, or balloon shape when viewed alongside its helical axis. The mounting may comprise a rod having a first portion rotatably connected to the axle so that the rod rotates around its length, the proximal end of the coil may be secured to the first portion of the rod, and the coil may extend helically along the length of the rod.

The device may be used in a railway car hopper, and may be permanently installed on the hopper. The device may be used to urge the flow of distiller's dry grains in a hopper.

In another embodiment, the device may be used incorporated into a system for removing bulk materials from a hopper, wherein the device is combined with a gate assembly such that when the gate is opened and the axle is rotated, the agitator or agitators urge bulk material from the hopper. In a further embodiment, the gate assembly comprises a frame, said frame comprising an upper flange that is attachable to an outlet flange of the bottom outlet of the hopper, and side panels extending downward from the flange when attached to the hopper. The gate assembly may further comprise a housing that supports the rotation of the one or more agitators, and a beam that attaches the housing to the frame. In a further embodiment, the axle may be mounted on the frame through sleeves mounted on openings in the side panels, and the axle further comprises collars on the portions of the axle abutting the sleeves so the axle is fixed laterally on the frame.

### BRIEF DESCRIPTION OF THE DRAWINGS

The invention can be better understood with reference to the aforementioned and following drawings and description. The components in the figures are not necessarily to scale, emphasis instead being placed upon illustrating the principles of the invention. In the drawings:

FIG. 1 is a side view of a hopper car with a “center-flow” design known in the prior art.

FIG. 1A is an end view of a hopper car with a “center-flow” design known in the prior art.

FIG. 2 is a cutaway side diagram of a hopper containing bulk material known in the prior art.

FIG. 3 is another cutaway side diagram of a hopper containing bulk material known in the prior art.

FIG. 4 is a side view of a hopper car with a “through-sill” design known in the prior art.

FIG. 4A is a cutaway end view of a hopper car with a “through-sill” design known in the prior art.

FIG. 5 is a slightly elevated view, with cutaway portions, of a device having a single agitator for urging bulk materials from a hopper, which is an embodiment in accordance with the present invention.

FIG. 5A is a side view, with cutaway portions, of device having a single agitator for urging bulk materials from a hopper which is an embodiment in accordance with the present invention.

FIG. 6A is a side view of a conically-shaped agitator which is an embodiment in accordance with the present invention.

FIG. 6B is a side view of an inverted conically-shaped agitator which is an embodiment in accordance with the present invention.

FIG. 6C is a side view of a cylindrically-shaped agitator which is an embodiment in accordance with the present invention.

FIG. 6D is a side view of a balloon-shaped agitator which is an embodiment in accordance with the present invention.

FIG. 6E is a side view of balloon-shaped agitator with center cable which is an embodiment in accordance with the present invention.

FIG. 6F is a side view of balloon-shaped agitator with a center rod which is an embodiment in accordance with the present invention.

FIG. 7 is an oblique view of a coupling for a device having a single agitator for urging bulk materials from a hopper, which is an embodiment in accordance with the present invention.

FIG. 8 is a picture of a pneumatic power wrench known in the prior art.

FIG. 8A is a picture of a shaft with a capstan known in the prior art.

FIG. 9 is an isometric end view of a coupling for actuating the axle in a device for urging bulk materials from a hopper, which is an embodiment in accordance with the present invention.

FIG. 10 is a slightly elevated view of a system having a single agitator for unloading bulk material from a hopper, an embodiment in accordance with the present invention.

FIG. 10A is a close up view of a portion of a system having a single agitator for unloading bulk material from a hopper, an embodiment in accordance with the present invention.

FIG. 10B is a top side view of a system having one agitator for unloading bulk material from a hopper, an embodiment in accordance with the present invention.

FIG. 11 is a slightly elevated a view of a device and system having four agitators for unloading a hopper, an embodiment in accordance with the present invention.

FIG. 12 is a transparent elevated view of hopper car showing the installation of a system having four agitators for unloading a hopper, an embodiment in accordance with the present invention.

FIG. 13A is a close-up view from the bottom of the central portion of a device having four agitators for urging bulk materials from a hopper, an embodiment in accordance with the present invention.

FIG. 13B is a close-up elevated view with cutaways of the central portion of a device having four agitators for urging bulk materials from a hopper, an embodiment in accordance with the present invention.

FIG. 14 is an oblique cut-away view of an installed system having four agitators for unloading bulk material from a hopper, an embodiment in accordance with the present invention.

FIG. 15 is a side partial cut-away view of an installed system having an agitator comprising multiple hubs for unloading bulk material from a hopper, an embodiment in accordance with the present invention.

FIG. 16 shows a spiral arm found on an agitator hub, an embodiment in accordance with the present invention.

FIG. 17 is a top cut-away view of an agitator hub with spiral arms and a torque limiter, an embodiment in accordance with the present invention.

FIG. 18 shows a spacer member used in the installed system having multiple hubs for unloading bulk material in an embodiment in accordance with the present invention.

FIG. 19 is a detail of the hub and coil structure of an installed system having multiple agitators, each having multiple hubs and coils for unloading bulk material from a hopper, an embodiment in accordance with the present invention.

FIG. 20 is a detail top cut-away view of a hub from an installed system having multiple agitators, each having multiple hubs and coils for unloading bulk material from a hopper, an embodiment in accordance with the present invention.

FIG. 21 is an oblique cut-away view of an installed system having four agitators for unloading bulk material from a hopper, an embodiment in accordance with the present invention.

### DETAILED DESCRIPTION

The device of the present invention may be used to agitate bulk materials near the bottom outlet of the hopper, which is where most problems of agglomeration occur. The device also avoids damage to the hopper by hammering, or by being agitated by “digger” equipment. Furthermore, a device according to the present invention may be configured so that it can be operated using the same equipment used in opening a hopper car gravity discharge gate.

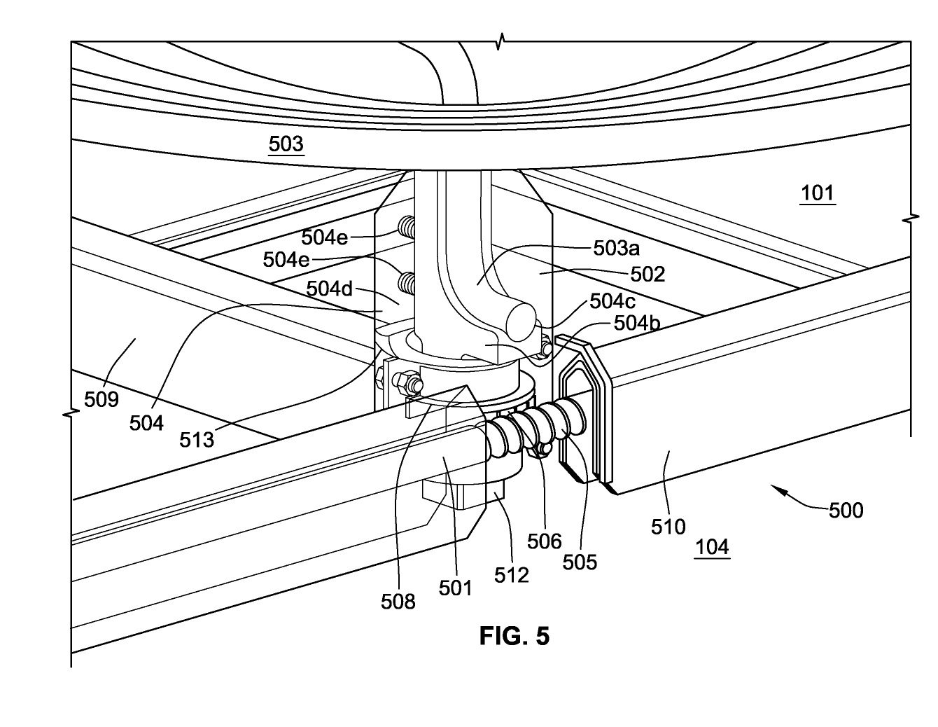

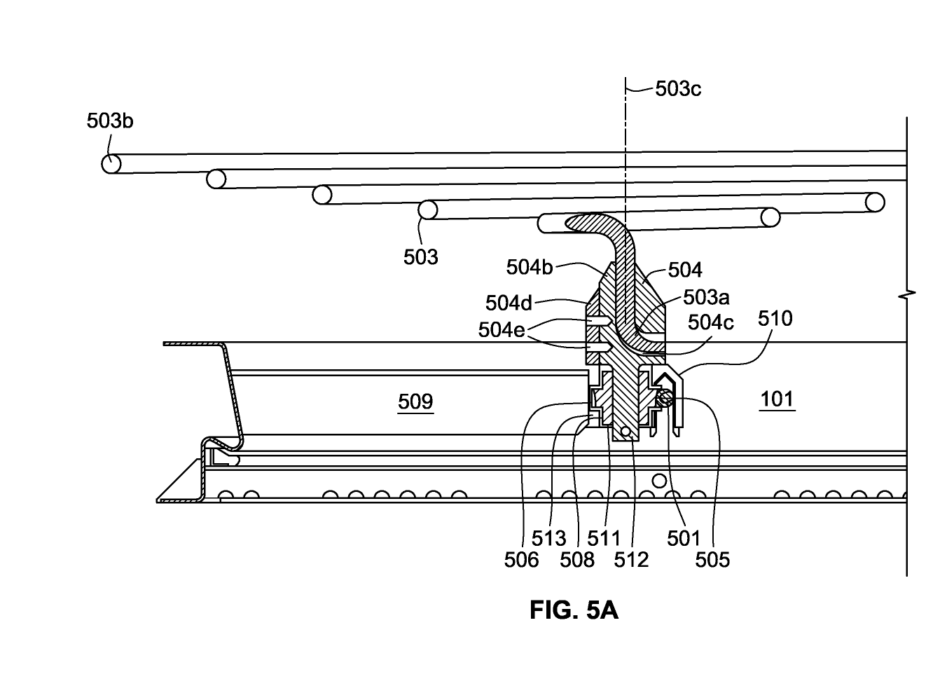

An embodiment of a device according to the present invention having one agitator is shown in FIG. 5. This embodiment of the device 500 comprises an axle 501. The axle 501 may be fixed to a hopper 101, or the axle may be supported by a separate supporting device, for example, a mobile unit that may be moved from hopper to hopper when unloading. The axle 501 is connected to a rotatable agitator 502 in such a manner that when the axle 501 is rotated, the agitator 502 rotates. Typically, the agitator 502 is rotatable around an axis that differs from the axis of rotation of the axle 501. For example, in this embodiment, the axis of rotation of the axle 501 is horizontal, while the agitator 502 rotates around a vertical axis.

The axle 501 and the agitator 502 in this embodiment are attached to a portion of the hopper 101. The axle 501 may extend across the hopper 101 and have one or both ends located outside the hopper 101, so that the axis 501 can be rotated using an external power wrench. The axis 501 may be secured to the hopper 101 by supports (not shown) that allow the axle 501 to rotate but not to slide laterally in the hopper 101.

When the agitator 502 is placed inside the bottom outlet of a hopper 101, and rotated by rotating axle 501, the agitator 502 will urge any bulk materials, such as DDG, soya meal, corn gluten, mulch, peat, and topsoil, and the like, inside the hopper to flow out of the bottom outlet 104. The agitator 502 may urge bulk materials to flow by pushing the bulk materials downward, or by breaking apart clumps of bulk material that have formed in the vicinity of the agitator 502.

An agitator 502 may be any device that, when rotated, will agitate the bulk material in the hopper and thus facilitate its flow toward a bottom outlet, including but not limited to rotating augers, screws, blades, coils, and shafts with vanes. Spiral augers or screws that rotate around a spiral axis may be used to impose on the bulk materials a directional force that is parallel to the spiral axis. The embodiment of agitator 502 shown in FIG. 5 comprises a coil 503 and a mounting 504, where the mounting 504 is rotatably connected to the axle. The coil 503 may be a metallic auger coil. This coil agitator has the advantage of displacing less volume in the hopper 101, and in allowing and encouraging the bulk material to fill in throughout the interstices of coil 503. The coil 503 may be secured to the mounting 504 so that the coil 503 rotates in the same axis of rotation with the mounting 504. The coil may be secured to the mounting by any means, including but not limited to retention screws or friction coupling.

As stated previously, the agitator 502 is connected to the axle 501 in a manner so that the rotation of the axle 501 will in turn cause the agitator 502 to rotate. If, in this instance, the agitator is vertical, and the axle horizontal, a horizontal gear 505 disposed on and rotating with the axle 501 is enmeshed with an agitator gear 506 rotatably connected to the agitator 502. This can be done by any combination that will transfer rotation from a horizontal to a vertical axis, including bevel gears. In FIG. 5, the horizontal gear 505 is a worm integrated with axle 501, and which is enmeshed with an agitator gear 506, which in this figure is a worm gear having a vertical axis of rotation. The agitator gear 506 may be supported by a bearing 508 such that the agitator gear 506 may freely rotate. The bearing in this embodiment is housed in a housing 513. The housing 513 may be secured in its place near the bottom outlet of the hopper by support beam 509, which secures the housing 513 to a portion of the hopper 101. The agitator gear 506 is rotatably connected to a central socket 511 (shown in FIG. 5A) that rotates with the same central axis as the agitator gear 506. In FIG. 5A, the central socket 511 is disposed inside the agitator gear 506 and is square-shaped. Into this central socket 511a rotating member 512 may be inserted. This rotating member 512 in this one-agitator embodiment comprises a square shaft disposed inside the central socket 511 and is rotatably attached to the mounting 504 or the agitator 502, so that the agitator gear 506, central socket 511, rotating member 512, and agitator 504 all rotate around the same axis of rotation. In this embodiment, the rotation of the axle 501 turns the axle gear 505, thus driving the rotation of the agitator gear 506 and the agitator 502.

Another view of this one-agitator embodiment of a device in accordance with the present invention is shown in FIG. 5A. The axle gear 505 of the axle 501 is enmeshed with a agitator gear 506. The agitator gear is supported by a bearing 508 that allows for the free rotation of the agitator gear 506. In this embodiment, the mounting 504 is disposed above the agitator gear 506, and is connected to the agitator gear 506 by a rotating member 512 extending down from the mounting 504 through a central socket 511 disposed at the center of agitator gear 506 so that the mounting 504 and agitator gear 506 both rotate around the same axis. The bearing 508 in this embodiment is substantially surrounded (except at the point of contact between axle gear 505 and agitator gear 506) by a housing 513, which may be anchored to the hopper 101 by a support beam 509. A conduit 510 surrounds the axle 501 along its length, as shown in FIGS. 5 and 5A, except the conduit is open at the point of contact between axle gear 505 and agitator gear 506.

Many configurations are possible for the coil 503 and mounting 504 of agitator 502. As shown FIG. 5, the coil 503 is attached to its mounting 504 at one end of the coil 503a. In FIG. 5, the end 503a is bent in an L-shape inside the mounting 504. The mounting 504 in this embodiment comprises a cradle member 504b that is integrated with the rotating member 512. This cradle member 504b is an approximately L-shaped member having a curved recess 504c in which the L-shaped coil end 503a partly rests. The mounting 504 further comprises a casing 504d that surrounds the cradle member 504b and coil end 503a so that the coil end 503a is entirely sandwiched between the cradle member 504b and casing 504d. The casing 504d is secured to cradle member 504b by bolts 504e. The casing 504d and cradle member 504b together form an essentially solid unit with an L-shaped burrow in which the coil end 503a is disposed. The coil end 503a is therefore geometrically constrained from moving in any direction with respect to the mounting 504.

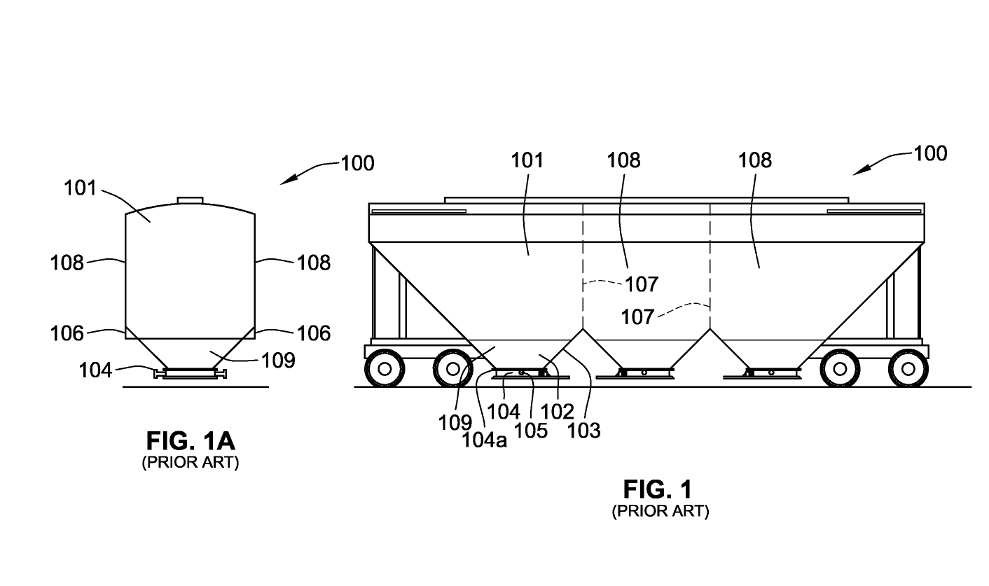

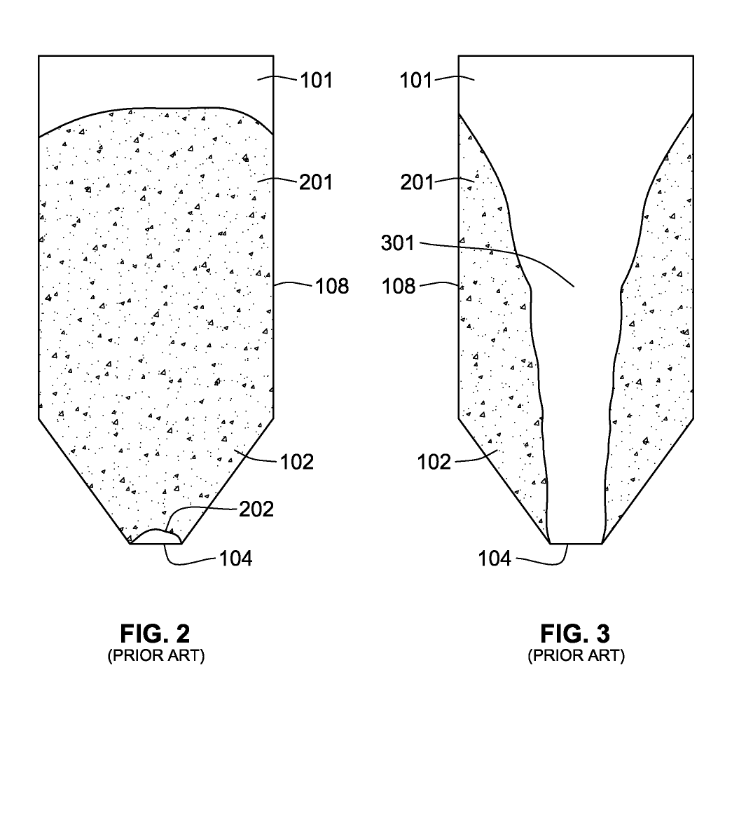

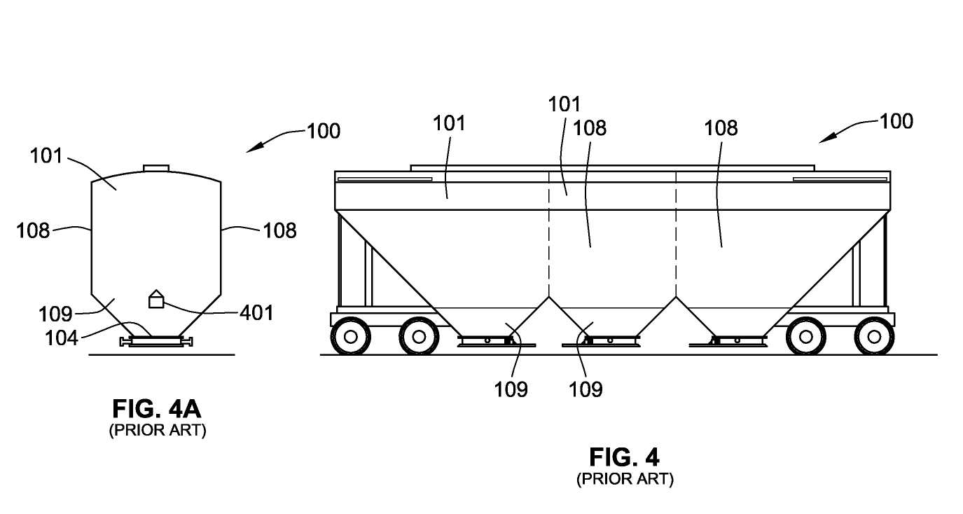

In FIG. 5, the coil 503 is helical, extending upward into the hopper 101 from the point where end 503a joins mounting 504 to the coil's distal end 503b. This helical coil defines a helical axis 503c that is aligned with the axis of rotation of the mounting 504. The helical coil 503 has a conical shape when viewed alongside its helical axis, being narrowest at the end 503a mounted to mounting 504, and widest at distal end 503b. This configuration allows the coil 503 to occupy the space along the slope sheets 102 of the hopper 101 (See FIG. 1). A number of other embodiments of a coil 503 and mounting 504 are also possible, and may be desirable depending on, among other things, the shape of the hopper 101, the nature of the bulk materials, and the orientation of the agitators 502 in the hopper 101. For example, an agitator 502 situated vertically inside the hopper, as shown in FIGS. 5 and 5A, may be desirable if the design of a hopper car 100 is such that there is no center sill 401 (see FIG. 4) to obstruct the agitator 502; however, such a configuration may not be desirable if a center sill 401 is disposed in the hopper.

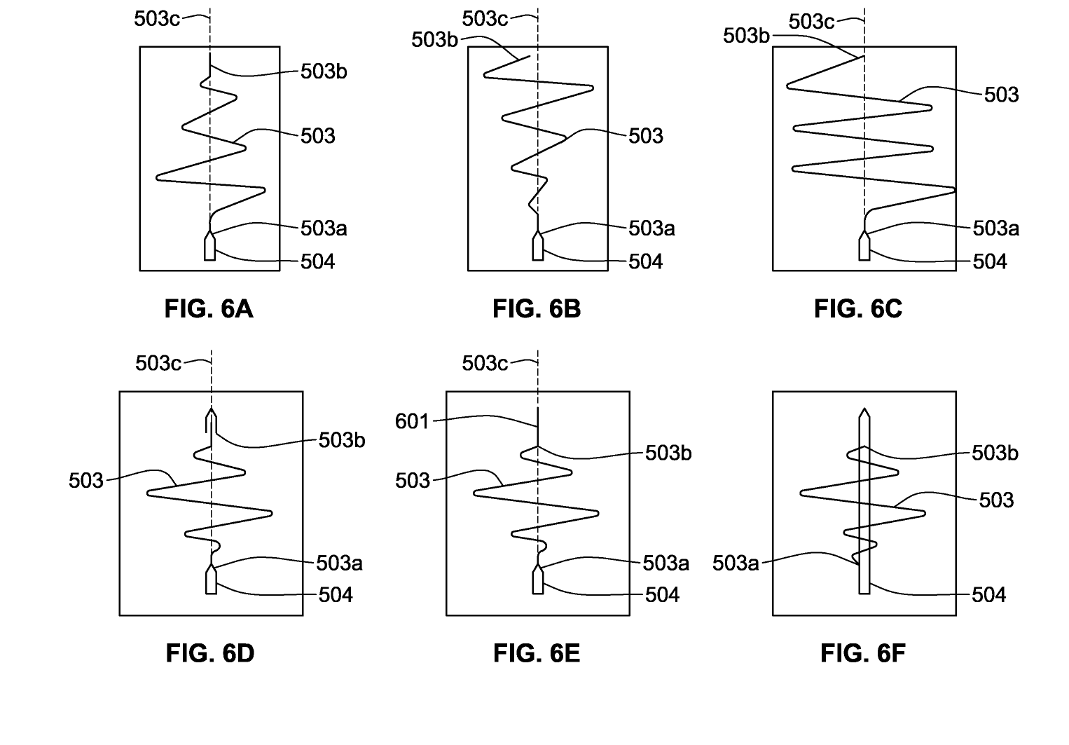

A few of the possible alternate embodiments of a coil 503 and mounting 504 are illustrated in FIGS. 6a-f. In FIG. 6a, a side view of a conically shaped coil agitator, the coil 503 is mounted to the mounting 504 at one end 503a and extends helically from the mounting 504, the helix being widest near end 503a, when viewed alongside the helical axis 503c, and narrowing along the helical axis 503c to distal end 503b.

FIG. 6b is a side view of an inverted conically-shaped coil similar to the embodiment of the coil 503 illustrated in FIG. 5. Like FIG. 5, the helical coil 503 is in a conical shape that is narrowest, when viewed alongside the helical axis, near the mounting 504 and widens all the way to distal end 503b.

FIG. 6c is a side view of a coil 503 having a cylindrical shape when viewed from the side along its helical axis 503c. In FIG. 6c, the coil 503 is attached to the mounting 504 at proximal end 503a and extends helically from the mounting 504, the helix having a constant width when viewed alongside the helical axis.

FIG. 6d is a side view of a coil 503 having a balloon shape when viewed alongside its helical axis. In FIG. 6d, the coil 503 is mounted to the mounting 504 at proximal end 503a and extends helically from the mounting 594, the helix being narrowest, when viewed alongside the helical axis, near the mounting 504 and at the distal end 503b, and widest at the point halfway between the mounting 504 and the distal end 503b.

FIG. 6e is a side view of a coil 503 having a balloon shape with an additional center cable. In FIG. 6e, the coil 503 is mounted to the mounting 504 at proximal end 503a and extends helically from the mounting 504, the helix being narrowest, when viewed alongside the helical axis, near the mounting 504 and at the distal end 503b, and widest at the point halfway between the mounting 504 and the distal end 503b. In addition, a center cable 601 secured to mounting 504 at one end extends from the mounting 504 along the helical axis 503c so that the cable is surrounded by the coil 503.

FIG. 6f is a side view of a coil 503 having a balloon shape on a center rod. In FIG. 6e, the mounting is a rod 602 having a proximal portion 602a that is connected rotatably connected to the axle. The rod 602 rotates around its length from proximal end 602a to distal end 602b. The proximal end 503a of coil 503 is attached to the rod at the proximal end 602a of the rod 602, and the distal end 503b of coil 503 is secured to the distal end 503b so that coil 503 does not move with respect to the rod 602. The coil extends helically from near end 503a to distal end 503b of the rod and is balloon-shaped when viewed alongside the helical axis, being narrowest at proximal end 503a and distal end 503b, and widest at the point halfway between the ends of the coil.

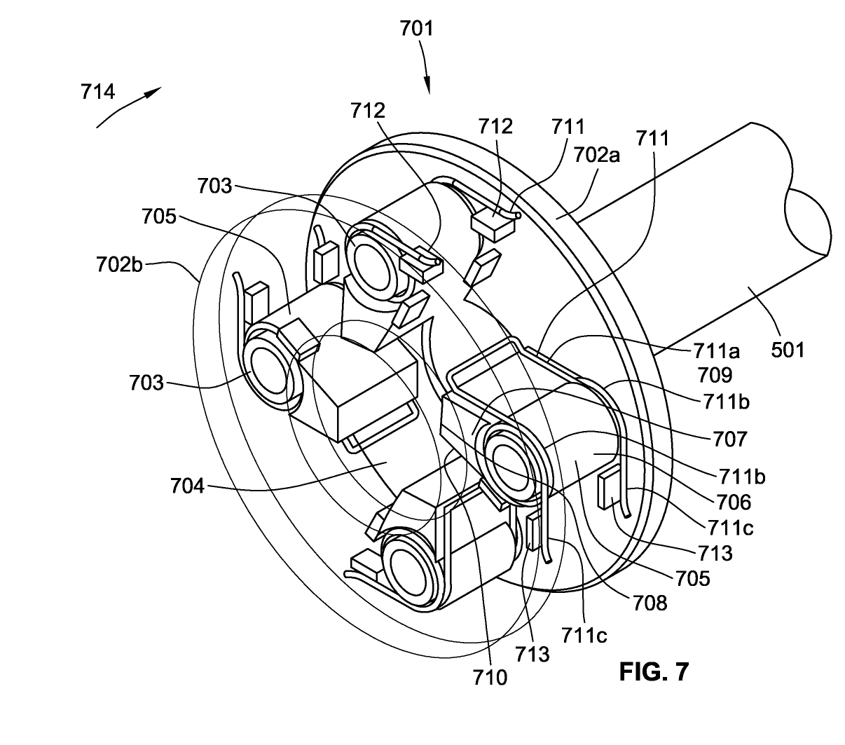

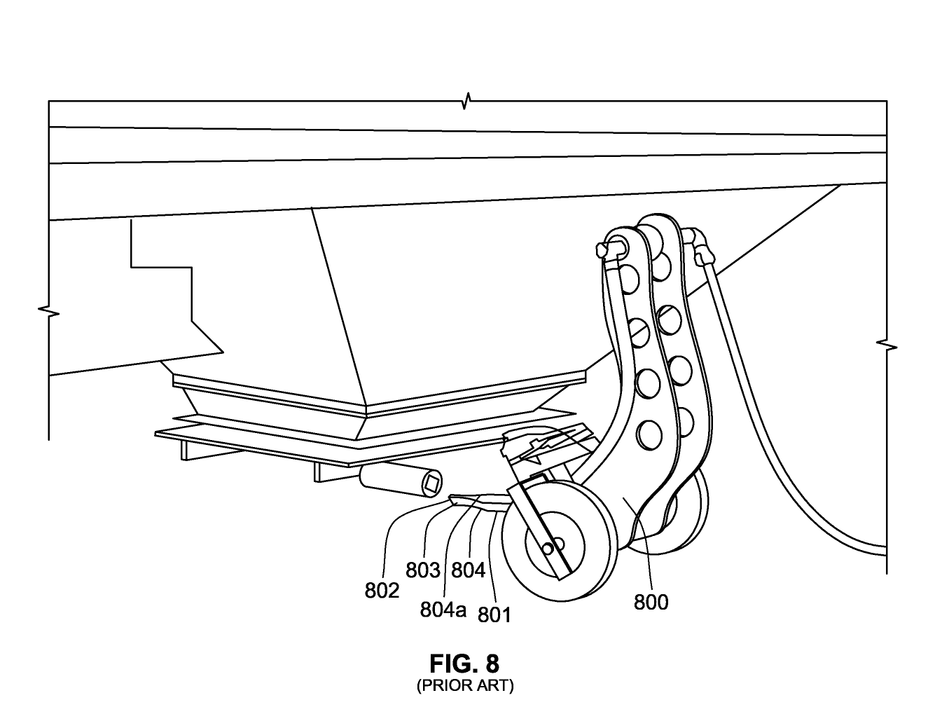

The axle 501 in a device of the present invention may be capable of being coupled to and actuated by an external power wrench. In an embodiment of an axle shown in FIG. 7, the axle 501 will have a coupling 701 on one or both ends of the axle 501. The coupling will have an access corridor 704 at its center that can accommodate the rotating drive bit of a power wrench, and be configured so as to transfer of the rotation of the drive bit to the axle 501.

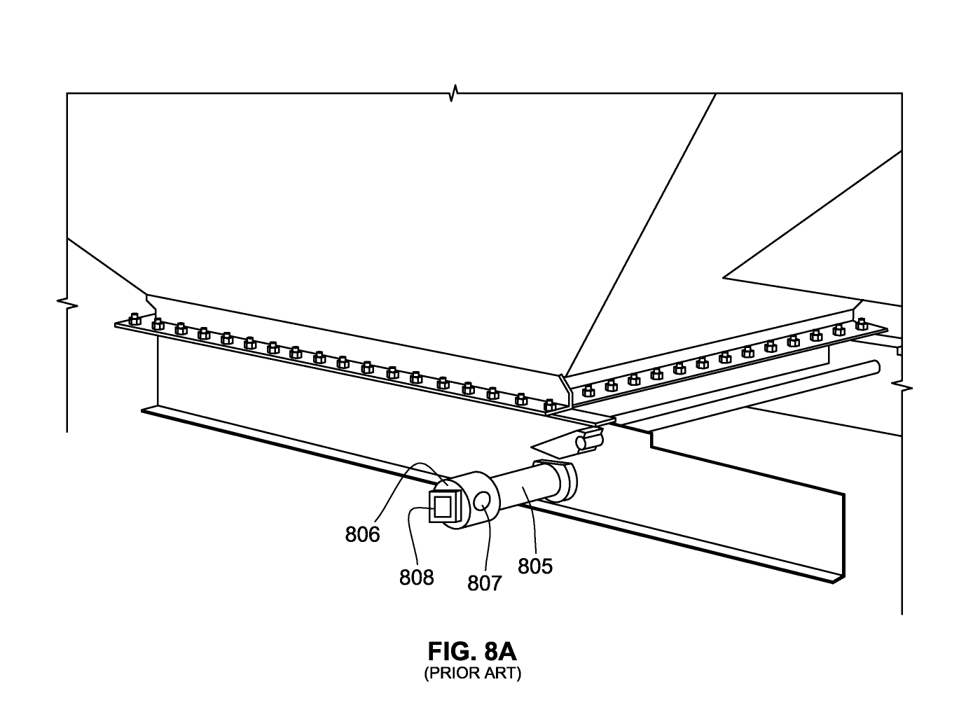

Power wrenches with drive bits are commonly used in the industry with hopper cars. One example of a power wrench is a hopper car gate opener, as illustrated in FIG. 8. A hopper car gate opener 800 comprises a pneumatically driven rotating shaft 801 ending in a drive bit 802. In this embodiment, the drive bit 802 has a tapered end 803 and widens to a four-sided portion 804 near where the drive bit 802 is attached to the shaft 801. The four-side portion 804 has four corners 804a. Some power wrenches are capable of producing over 13,000 ft-lbs. of torque. Other wrenches may also be used in lieu of the hopper car gate opener 800, including all manner of hand-driven, motorized, hydraulic, or pneumatic wrenches or screwdrivers.

The rotation of axle 501 may be actuated through the pneumatically driven rotation of the four-sided portion 804 inside a coupling that accommodates the four-sided portion 804. A common coupling used in the hopper car industry is the capstan shown in FIG. 8A. In FIG. 8A, a shaft 805 (which in this figure is used to operates the sliding gate of a hopper when rotated) has at its end a capstan 806 having a four-sided outlet 808 leading into a recess 807 along the length of the shaft 805. The drive bit 802 of a power wrench 800 may be inserted into the recess 807 so that the four-sided portion 804 of the drive bit 802 engages the square shaped outlet 808. When the drive bit 802 is rotated in the recess, the rotation of the four-sided portion 804 is transferred to the four-sided outlet 808, thereby turning the shaft 805.

While in some embodiments of a device of the invention, the axle 501 may be rotated in either rotational direction, and in turn rotate the agitator 502 in either rotational direction, the design of the agitator 502 may be such that one rotational direction of the agitator is preferred for optimal operation. For example, a helical coil, such as that shown in FIG. 5, will tend to compact the bulk materials downward when rotated in one direction, and will tend to drive the bulk materials upward when rotated in the other direction. Thus, it may be preferable that the axle 501 be allowed to rotate in only one direction.

Therefore, in one embodiment of the invention, the coupling 701 will be any clutch or ratchet-type coupling that will allow an inserted wrench or other power wrench to rotate the axle 501 in only one direction, and thus rotate the agitator 502 in only one direction. Returning to FIG. 7, one embodiment of such a coupling 701 for use with a four-sided drive bit may comprise an inner wheel 702a attached to an end of axle 501 and an outer wheel 702b parallel to the inner wheel 702a. In this figure, the coupling 701 allows rotation in the desired direction (in this instance, clockwise when viewed from the side opposite the axle 501), as indicated by curved arrow 714. The wheels 702a and 702b have circular openings bored through them forming an access corridor 704, so that the drive bit 802 of a power wrench (see FIG. 8) may be accommodated therein. The end of the axle 501 may also have a circular opening so that the access corridor 704 may accommodate the tapered end 803 of the drive bit 802. In this embodiment, four posts 703, which are cylinders in this embodiment, are disposed peripherally around the access corridor 704 and at ninety degree angles from one another. The posts 703 in this embodiment connect the wheels 702a and 702b at either end of the posts 703. Around each post 703 is disposed a rotation stop 705 that can rotate around the post 703. Each rotation stop 705 in this embodiment comprises a cylinder 706, that fits around the post 703, and a three-sided tooth 707. Each tooth 707 has a front side 708 at the end opposite the cylindrical cavity 703. A straight side 709 of the tooth 707 extends from the cylindrical cavity 706 and meets the front side 708 at a right angle. An oblique side 710 of the tooth 707 extends from the cavity 706, and meets the front side 708 at an oblique angle. The oblique side 710 is situated so that it is the leading side if the wheels 702a and 702b are rotated in the desired direction.

A torsion spring 711 connects each post 703 and rotation stop 705. Each torsion spring 711 operates to bias the rotation stop 705 to move to its engaging position. The torsion spring 711 shown in FIG. 7 is a wire having two wire ends 711c that is bent in a U-shape with a closed end 711a and two branches 711b extending from the closed end. The closed end 711a of the U-shaped wire abuts the straight side 709 of each tooth 707. The two branches 711b of the U-shaped wire are wrapped once around the ends of post 703 near where the post 703 is joined to wheels 702a and 702b. The wire ends 711c are tucked next to spring tabs 713, the spring tabs being attached to wheels 702a and 702b. Thus, displacing a rotation stop 705 against closed end 711a around its corresponding post 703 will deform the spring 711, because the ends 711c of the spring are constrained by spring tabs 713. The spring 711 will thus tend to return to its engaging position as the closed end 711a pushes the straight side 709 around the post 703. Each rotation stop 705 is held in an engaging position by two rotation stop tabs 712 that are disposed on wheels 702a and 702b and which abut the oblique side 710 of each rotation stop 705 when the rotation stop is in its engaging position. The rotation stop tabs 712 therefore prevent the torsion spring 711 from pushing the rotation stop 705 beyond its engaging position.

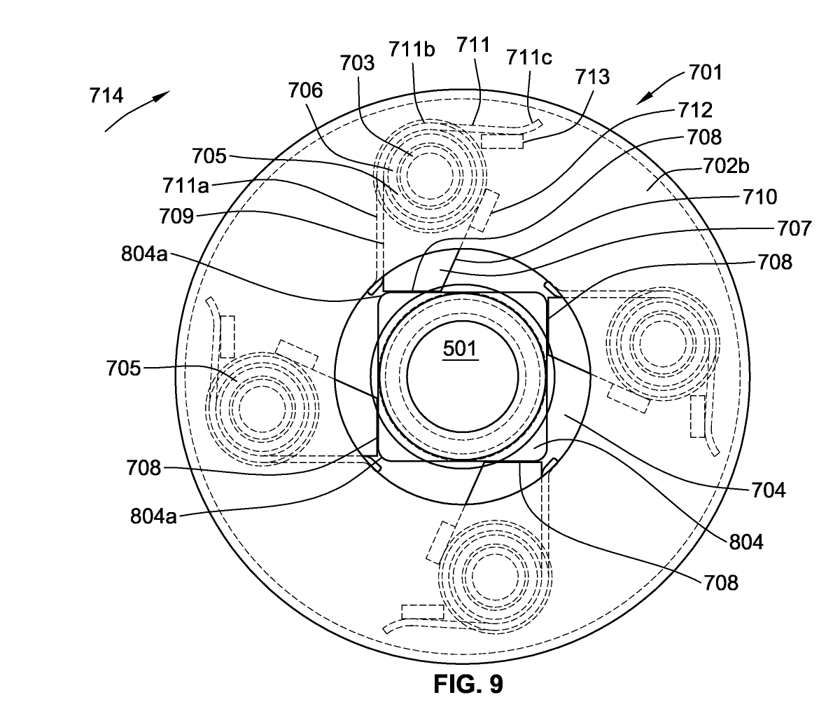

As shown in FIG. 9, the engaging position of each rotation stop 705 is such that, when a line is drawn along the front sides 708, said lines will form a square, the square being sized to accommodate the four-sided portion 804 of the drive bit 802 of a power wrench 800 (see FIG. 8). When the drive bit 803 of the power wrench 800 is inserted into the access corridor 704 so that the four-sided portion 804 is disposed between the rotation stops 705, the four-sided portion 804 can then be driven in the desired or undesired direction by the power wrench 800. If the four-sided portion 804 of drive bit 802 is turned in the undesired direction, the corners 804a of the four-sided portion 804 will push against the oblique side 710 of each rotation stop 705, displacing each rotation stop 705 around post 703. After each corner 804a of the four-sided portion has passed, the torsion spring 711 will push each rotation stop 705 by pushing the straight side 709 until the rotation stop 705 returns to its engaging position abutting rotation stop tabs 712. In this manner, the drive bit 802 may freely rotate in the undesired direction, but will not transfer rotational motion to the coupling 701.

If on the other hand, the four-sided portion 804 is turned in the desired direction 714, each corner 804a of the four-sided portion 804 will engage the front side 708 of each rotation stop 705. However, because the rotation stop is constrained from being displaced by tabs 712 and the bias of torsion spring 711, the four-sided portion 804 will be constrained from freely rotating in the desired direction without also rotating the coupling 701 and axle 501 in the desired direction. In this manner, the drive bit 802 may transfer its rotation in the desired direction 714 to the coupling 701.

In like manner, a second coupling can be attached to the second end of the axle 501 to drive the axle in the desired direction. However, for the second coupling to drive the axle 501 in the same desired direction, the second coupling must be configured so that its rotation stops will be displaced around the posts when the drive bit is inserted in the clockwise direction (when viewed from the side opposite the axle).

While the device 500 composed of the axle 501 and agitator 502 may comprise a device that may be installed in a hopper, a system combining an agitating device with a gate assembly is also contemplated. Thus, such a system can serve as a replacement for gate assemblies currently installed on hopper cars.

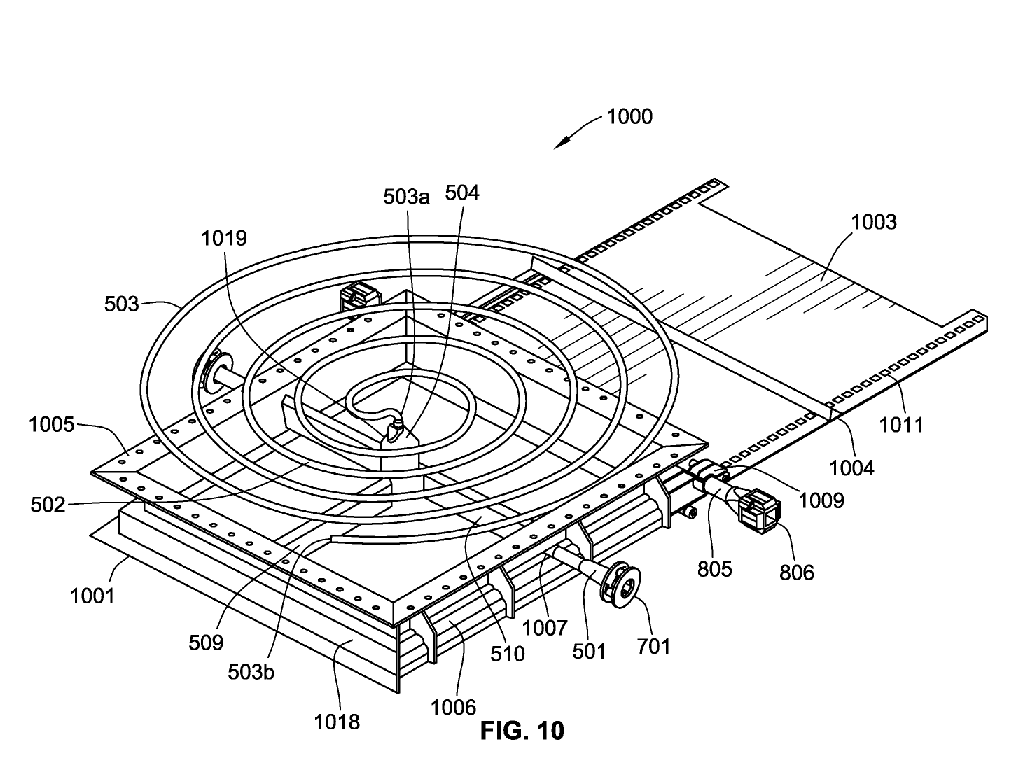

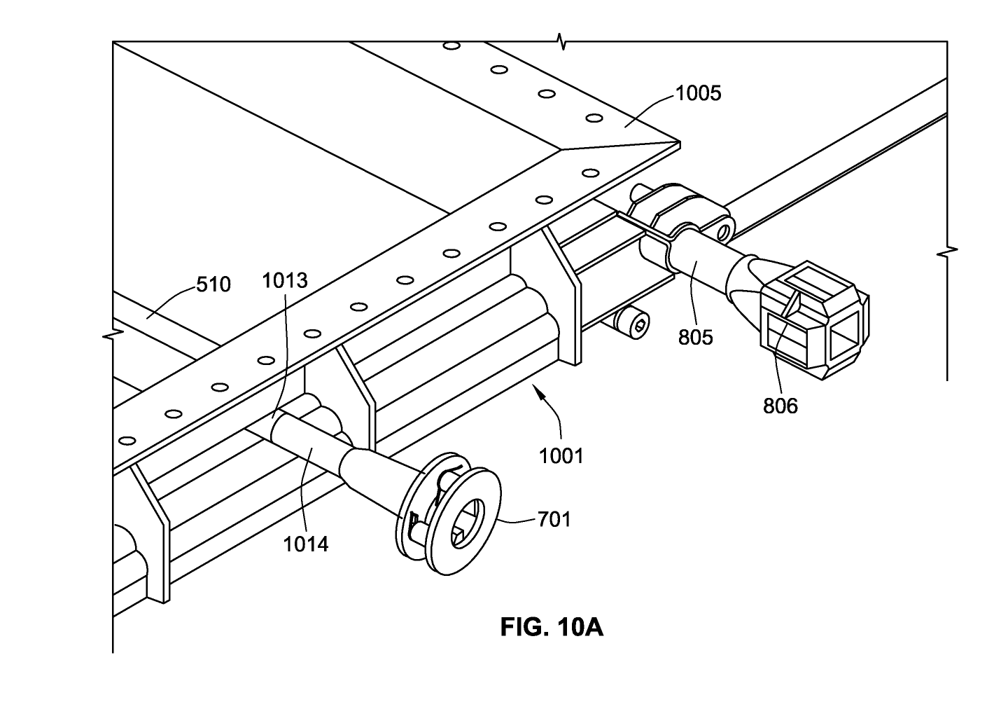

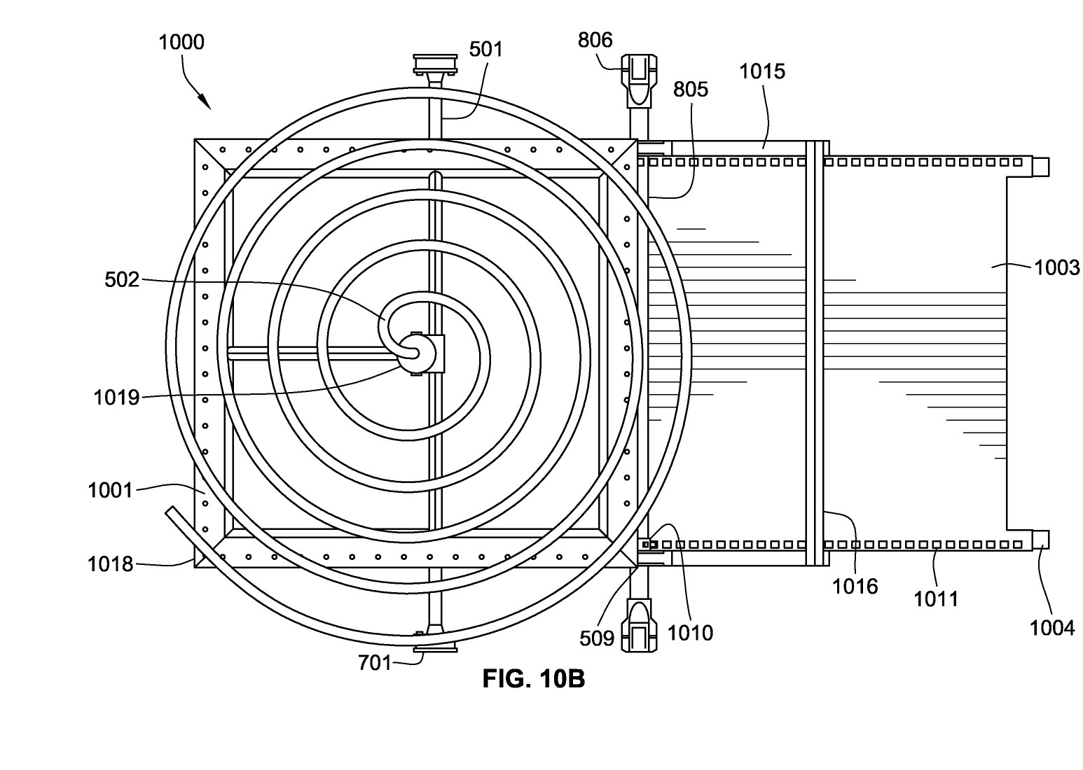

One embodiment of such a system 1000 is shown in FIG. 10. However, many currently used hopper gate assemblies can be modified with the device of the claimed invention. The system 1000 in this embodiment comprises a gate assembly 1018 with an agitator 502 comprising a coil 503 and mounting 504. The gate assembly 1018 comprises a door panel 1003 that is a sufficient size for covering the bottom outlet 104 of a hopper 101, and rails 1004. The door panel 1003 in this embodiment has two edges 1003a that are curved downward, so as to fit into two rails 1004. These rails 1004 are of a sufficient length to support the door panel 1003 in two adjacent sliding positions, and are designed to accommodate the curved edges of the door panel 1003.

The gate assembly 1018 further comprises a frame 1001 that supports rails 1004. This frame 1001 has an upper flange 1005 that can be secured to the outlet flange 104a of bottom outlet 104 of the hopper 101 (see FIG. 1) by bolts, screws, or other fasteners, and four side panels 1006 extending a distance below the flange 1005. The rails 1004 are disposed below two opposing side panels 1006 opposite the flange 1005, so that the side panels 1006 define a space between the bottom outlet 104 and the gate 1002. The rails 1004 extend along the side panels 1006 and for a distance beyond the side panels 1006 so that the door panel 1003 can be supported in an open and a closed (directly below the bottom outlet) position. When the door panel 1003 is slid along the rails into the rectangle formed by four side panels 1006, the door panel 1003 closes the hopper 101. The four side panels 1006 in this embodiment define a space of sufficient distance from upper flange 1005 to rails 1004 so as to accommodate the axle 501 and at least a portion of the mounting 504 of the agitator 502. A beam 509 connects a side panel 1006 to a housing 513, and the housing 513 supports the agitator 502. The housing 513 contains a bearing 508 that supports the mounting 504.

The system further comprises an operating system 1019 for rotating the agitators. In this embodiment, the operating system 1019 includes an axle 501 that extends across the frame 1001 through two openings 1007 in the side panels 1006. The axle 501 may terminate at a coupling 701 at either or both ends that allows for a power wrench 800 to be attached to and drive the rotation of the axle 501. A conduit 510 attached to side panels 1006 surrounds the axle 501 along its length in the frame so as to protect its rotation from being impeded by bulk materials in the hopper. Similarly to FIG. 5, the operating system 1019 also includes an axle gear (not shown) rotatably connected to the axle, and an agitator gear 506. Similarly to FIG. 5, the agitator gear (not shown) is contained in housing 513 and is rotatably coupled to the agitator 502.

In order to maintain the rotation of the agitator 502 by the axle 501, the axle 501 should not be allowed to slide back and forth through the openings 1007. Thus, the axle 501 may have collars that fix the axle's lateral position in the frame 1001. In one embodiment, shown in FIG. 10A, the axle 501 is supported on the frame 1001 by sleeves 1013 that are attached to the frame 1001 at the openings 1007 and which support the axle 501 and allow it to freely rotate. The portions of the axle 501 outside the frame have collars 1014 fixed on the axle in such a manner that the collars 1014 abut the sleeves 1013 at the ends of the axle 501 outside the frame 1001, so that the lateral position of the axle 501 in the frame 1001 is fixed.

Another top side view of the system 1000 is shown in FIG. 10B. The rails 1004 are shaped to fit under the downward curved edges of the door panel 1003. The gate may also constitute two rail supports 1015 attached to the rails 1004 away from the frame 1001, so as to provide support to the gate 1002 when the door panel 1003 is in the opened position. The gate may further comprise a bridge member 1016 between the rail supports 1015 to provide further lateral support to the rails 1004.

The gate may also comprise a rotating shaft 805 that may be mounted to the frame 1001 by bearings 1009 so that the shaft 805 is perpendicular to rails 1004. On this shaft 805 may be disposed one or more toothed pinions 1010. There may also be disposed on the door panel 1003 one or more racks of apertures 1011 aligned with the pinions 1010 and parallel to rails 1004, so that when the shaft 1008 is turned, the teeth of the pinions 1010 engage the apertures 1011 so as to push the door panel 1003 to slide back and forth on the rails 1004, dependent on what direction the shaft 1008 is turned. Thus the gate 1002 may be opened and closed.

Furthermore, the shaft 805 may have capstans 806 at either or both ends. In a preferred embodiment, these capstans 806, similar to the capstan 806 described in FIG. 8A, can be connected to and be turned by a power wrench, preferably one that uses a similar drive bit as can be used in the coupling 701, as shown in 803 of FIG. 8. Thus, the capstans 806 shown are capable of accommodating a drive bit 803 having a four-sided portion 804, as shown in FIG. 8. Rotating the drive bit 804 inside the capstan 806 will turn the shaft 805 and thus slide the door panel 1003 open and shut over the frame 1001. Thus, the power wrench 800 can be used to first open the gate 1002 of a hopper by turning the shaft 805 through capstan 806. The power wrench 800 can then be attached to either one of couplings 701 to actuate the rotation of axle 501 in order to drive the rotation of agitator 502 inside the hopper 101. In this manner, bulk materials are urged to flow out of the bottom outlet 104 through the opened gate 1002.

A single-agitator embodiment of the device and system as shown in FIGS. 5 and 10, having a vertically oriented agitator, may be desirable in a hopper that has no vertical obstacles to the hopper inside, for example, the “center-flow” design of FIG. 1A. However, if the hopper has an obstruction above the bottom outlet, as in the “through-sill” design shown in FIG. 4A, the agitator or agitators will need to be designed so that it is not interfered with by the center sill 401.

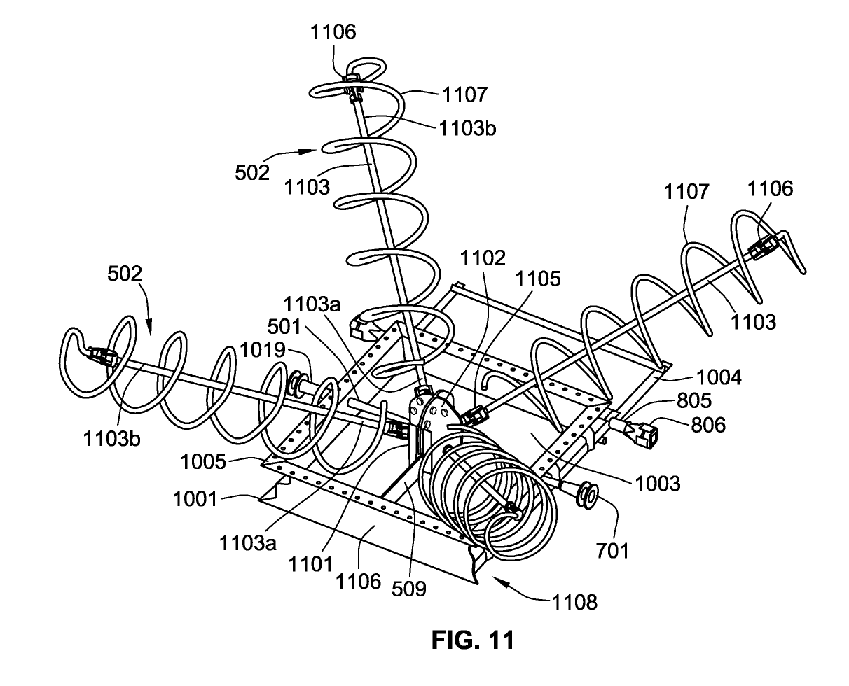

The design of a device or system of the claimed invention is not limited to one agitator attached to an axle; any design having one or more rotatable agitators may be used. An example of a four-agitator device 1101 of the claimed invention is shown in FIG. 11. In this top side view, an axle 501 can be seen, the axle having couplings 701 that can be coupled to a power wrench to actuate the axle 501. As described in FIGS. 7 and 9, the couplings 701 may be designed to actuate the axle in only one desired direction.

In this embodiment, there are four agitators 502 that extend from a central housing 1102. The central housing 1102 contains a rotatable coupling (described below) that connects the axle 501 with each of the agitators 502. While many agitator designs may be used, including the agitators shown in FIGS. 5 and 6, each agitator 502 in this embodiment comprises a comprises a rod 1103 having a proximal end 1103a. The rod 1103 is connected to at the rod's proximal end 1103a by a proximal universal joint 1105 which is rotatably coupled to the axle 501. The agitator 502 further comprises a distal end 1103b of the rod 1103, a distal universal joint 1106 that connects the distal end 1103b to a coil 1107. The coil 1107 extends helically from mounted end 1107a connected to the distal universal joint 1106 to free end 1107b, and is disposed so that the coil 1107 encircles rod 1103 and helically extends along the rod 1103 so that free end 1107b is near the proximal end 1103a of the rod 1103. The coil 1107 in this embodiment has a cylindrical shape when viewed alongside its helical axis, although other shapes may be used. Each bar 1104 may rotate in the housing 1102, and rotating the shaft will cause the rod 1103 to rotate around its length on proximal universal joint 1105. The coil 1107 will then rotate around its helical axis on distal universal joint 1106.

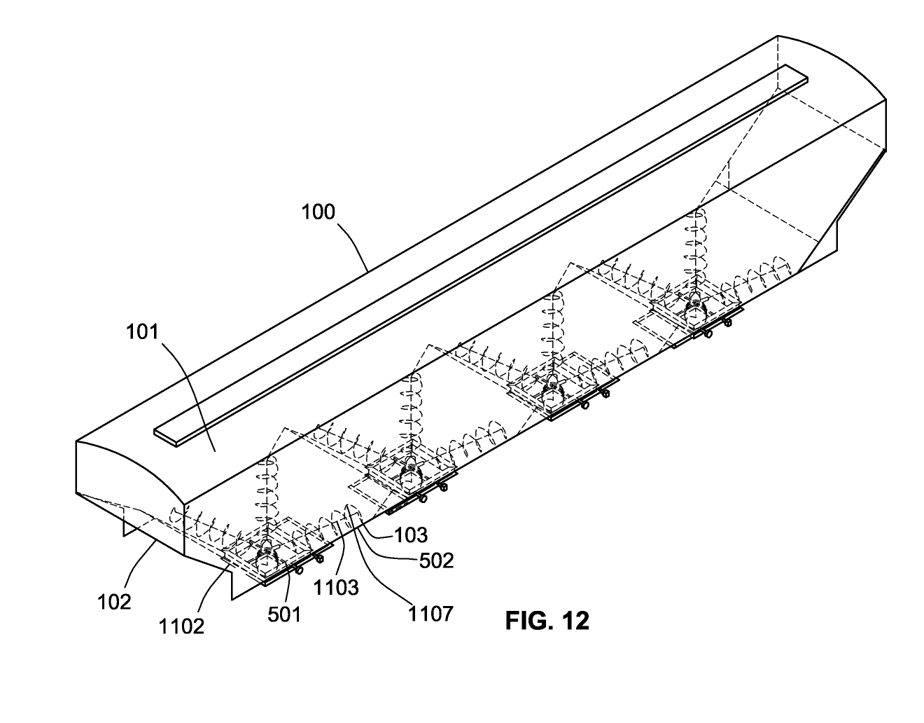

Another view of a four-agitator device 1101 installed in a hopper 101 in accordance with the present invention is shown in FIG. 12. In FIG. 12, a hopper car 100 has in each hopper 101 an axle 501 and four agitators 502 as described for FIG. 11. As can be seen, the rod 1103 and coil 1107 of each agitator 502 are disposed to extend along each sloping valley 103. Because the rod 1103 and in turn each coil 1107 are rotatably connected to the axle through universal joints (as shown in FIG. 11), each rod 1103 will extend upward approximately parallel to a sloping valley 103 from the central housing 1102. Because the sloping valleys 103 of the hopper 101 are at a lower angle than the slope sheets 102, each coil 1107 will, aided by gravity and the universal joint connections with the rod 1103, rest along a sloping valley 103 of hopper 101, cradled by two slope sheets 102. Each coil 1107 will rotate around its helical axis, which will be approximately parallel to a sloping valley 103. The agitators 502, when rotated in the hopper 101, serve to urge bulk materials in the hopper 101. The agitators 502 in this configuration by driving bulk materials toward the bottom outlet 104, by breaking up clumps of material, and agitating the bulk materials in hopper 101. Furthermore, there is no need to secure the agitators 502 inside the hopper 101 except at the central housing near the bottom outlet, as the coils 1107 will naturally rest in the sloping valleys 103. The ends of the agitators 502 are loosely confined by the corner defined by the side walls 108 of the hopper 101 and the cross car sheets 107 that divide the hoppers (see FIG. 1). This makes the device easy to install, as all the fixtures can be attached near the bottom outlet, or as part of a detachable gate assembly, without further installation inside the hopper.

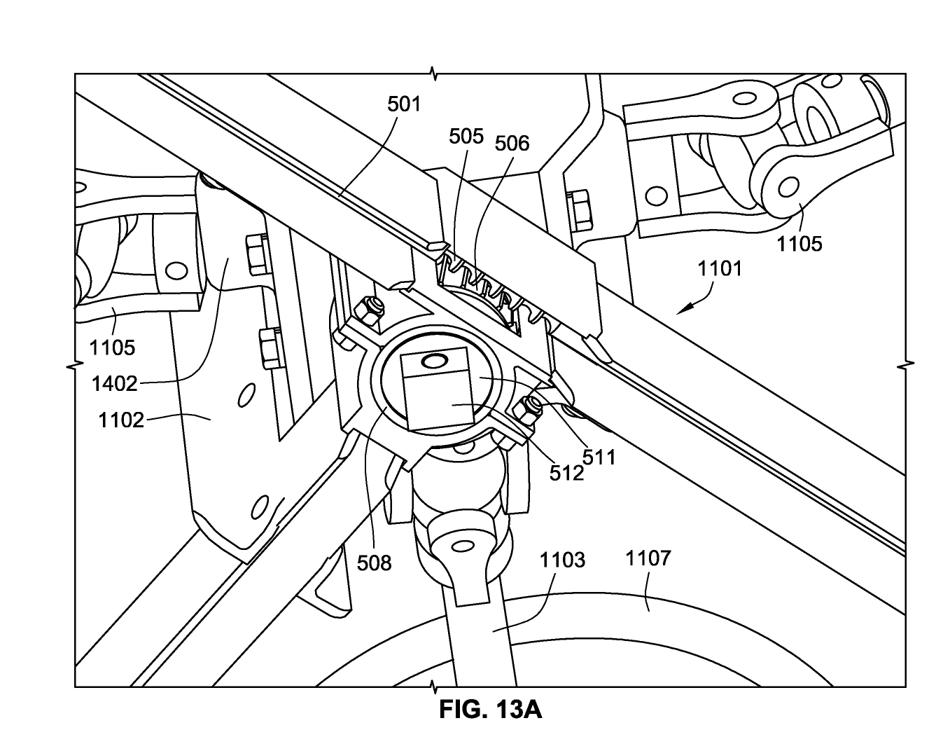

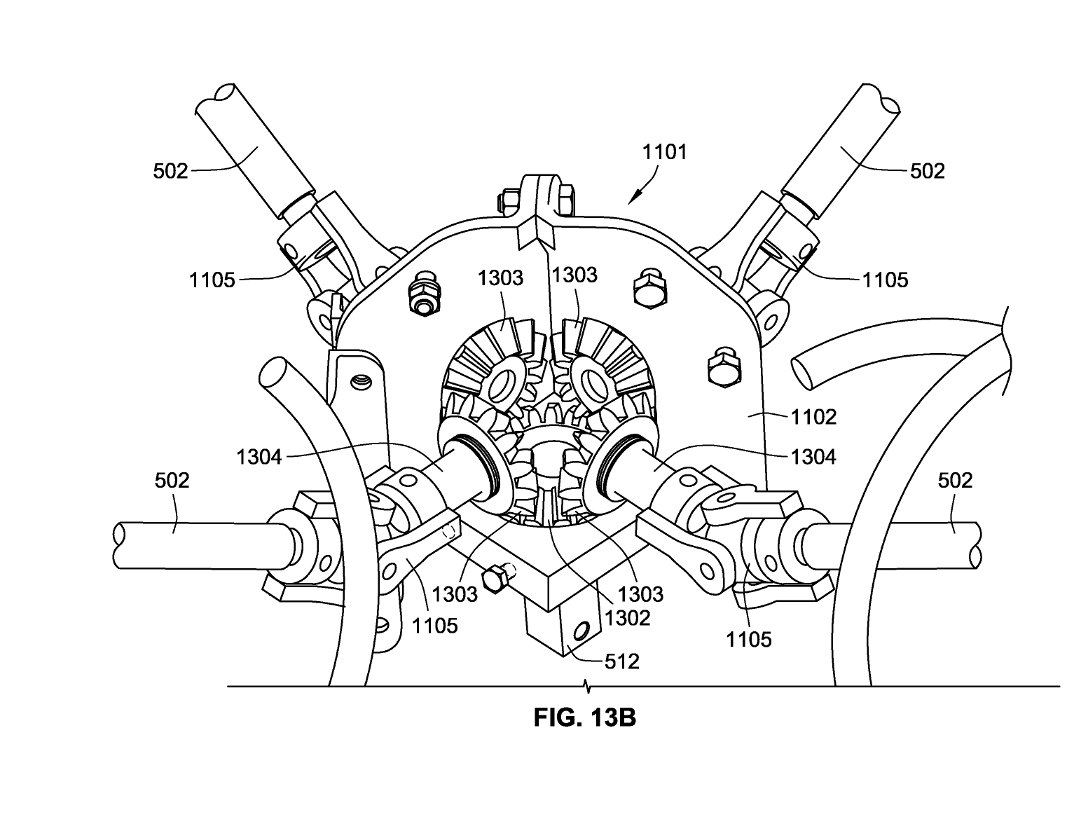

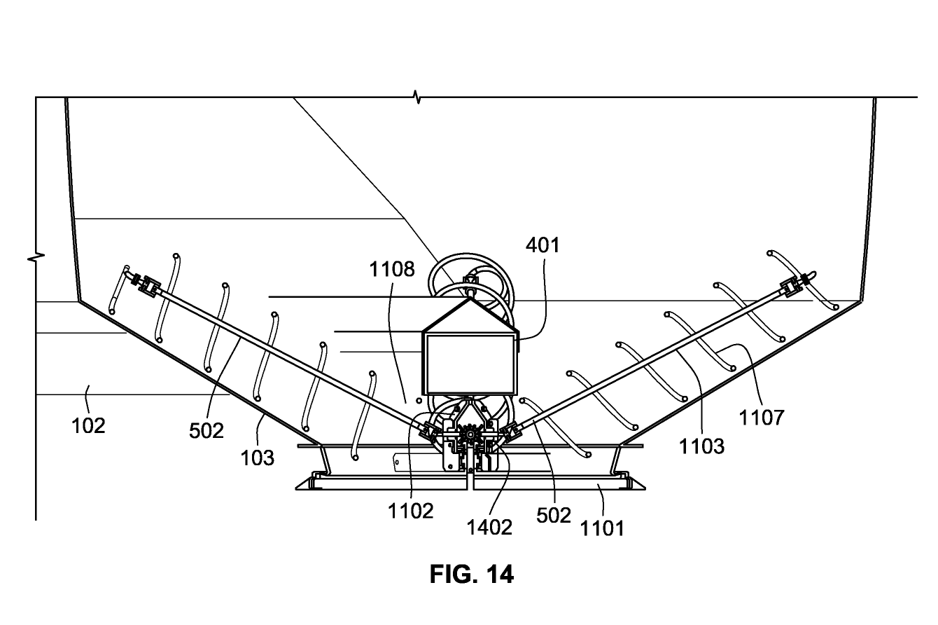

The agitators 502 may be driven by the axle 501 by any rotatable coupling means. One embodiment for driving agitators is shown in a bottom view in FIG. 13A. In FIG. 13A, the axle 501 incorporates an axle gear 505, in this case a worm gear, that is enmeshed with and drives the rotation of agitator gear 506 when the axle 501 is rotated. This agitator gear 506 is supported by a bearing 508 contained in the central housing 1102. The agitator gear 506 surrounds and is rotatably connected to a central socket 511. The central socket in this embodiment is square shaped, and supports a rotating member 512 that drives the rotation of the agitators 502. The rotating member 512 in this embodiment is a four-sided shaft. Turning to the top side of the device in FIG. 13B, it can be seen that, rather than be directly attached to the agitators 502 (as in the one-agitator embodiment), the rotating member 512 is rotatably connected to a central gear 1302 above the agitator gear 506, also housed in the central housing 1102. Thus, when the axle 501 is turned, the agitator gear 506 and central socket 511 are turned in a horizontal plane, thus rotating the rotating member 512, and driving the rotation of central gear 1302 in a horizontal plane above the agitator gear 506. The central gear 1302 is in communication with the four peripheral gears 1303. Each peripheral gear 1303 is also contained in central housing 1102. In this embodiment, the central gear 1302 and peripheral gears 1303 are beveled so that the axis of rotation of each peripheral gear 1303 is at a right angle with that of the central gear 1302. Thus, the rotation of the central gear 1302 causes each peripheral gear 1303 to rotate, thus driving the rotation of a bar 1304, connected to each peripheral gear 1303. The bar 1304 in turn rotates each agitator 502 through proximal universal joint 1105, as described for FIG. 11. The central housing 1102 incorporates bearings 1402 (shown in FIGS. 13A and 14) that surround the bars 1104 and support the rotation of each of the bars 1104 by its associated peripheral gear 1303.

Returning to FIG. 11, it can be seen that this four-agitator device 1101, like the one-agitator embodiment shown in FIG. 5, can either comprise a standalone unit, or a gate assembly can be modified with agitators to form an unloading system. Thus, as seen in FIG. 11, a system 1108 may comprise agitators 502 and a gate assembly 1018. The gate assembly 1018 has a frame 1001 with an upper flange 1005 that may be attached to an outlet flange 104a of a hopper 101 (see FIG. 1), and four side panels 1006. The central housing 1102 that supports the agitators 502 may be connected to a side panel 1006 of the frame 1001 via a beam 509.

The gate assembly 1018 further comprises a gate 1002 attached to frame 1001. The gate 1002 has a door panel 1003 and rails 1004, and may further incorporate a turning shaft 805, mounted to frame 1001, that causes the door panel 1003 to slide back and forth along the rails 1004 through a rack and pinion arrangement (shown in detail in FIG. 10B). The shaft 805 can thus be operated to open and shut the gate 1002. The shaft 805 may have a capstan 806 that can accommodate and be operated by an external power wrench 800 (seen in FIG. 8).

The operating system 1019 comprises an axle 501 and a rotating connection (not shown) inside central housing 1102 that rotatably connects the axle 501 to the agitators 502. The connection may constitute the same rotatable connection between the axle 501 and agitators 502 as is shown in FIGS. 13A and 13B. The axle 501 may extend through two openings 1007 in the side panels 1006, similarly to the system of FIG. 10.

The axle 501 may have a coupling 701 on one or both ends that can accommodate an external power wrench 800 (seen in FIG. 8). The coupling 701 may be capable of actuating the axle 501 in only one direction. Thus, the system 1108 can be operated using a power wrench 800 as shown in FIG. 8, by first opening the gate 1002 by turning the shaft 805 so as to slide the door panel 1003 along rails 1004. The same power wrench can then activate the operating system 1019 that rotates the agitators 502 inside the hopper 101 by inserting the drive bit 802 into one of the couplings 701 and actuating the rotation of axle 501. In this manner, the agitators 502 are rotated, and the agitators urge bulk materials in the hopper downward and out through the bottom outlet.

An advantage of this embodiment in accordance with the present invention can be illustrated in FIG. 14. In this oblique cutaway view of a hopper 101 of the “through-sill” type, a center sill 401 extends through the hopper 101. The system 1108 in this embodiment is installed at the bottom outlet 104 of the hopper. As can be seen, the central housing 1102 of the system 1108 can be partially contained inside the frame 1101, and thus can be completely disposed below the center sill 401. The agitators 502 of the system 1108, being disposed toward the sloping valleys 103 and slope sheets 102 of the hopper 101, are able to freely rotate without interference from the center sill 401. The agitators 502, are disposed around the center sill 401 so as to agitate and urge downward bulk materials around the center sill 401.

It may be desirable, in cases of heavily caked loads, to use agitators comprised of separate augers that are rotationally decoupled from one another. In that case, if one of the augers is not able to rotate against the caked material, it does not prevent the other augers in the system from rotating against the caked material. Therefore, in another embodiment according to the invention, the agitator comprises a series of spiral arms that separately rotate in relation to a rotating vertical shaft. A system of this embodiment can be incorporated into either the “one-agitator” embodiment (as shown in FIG. 5), with one vertical agitator 502 attached by a worm gear to the axle 501, or it can be incorporated into the four-corner agitator system 1101 (as shown in FIGS. 11-14).

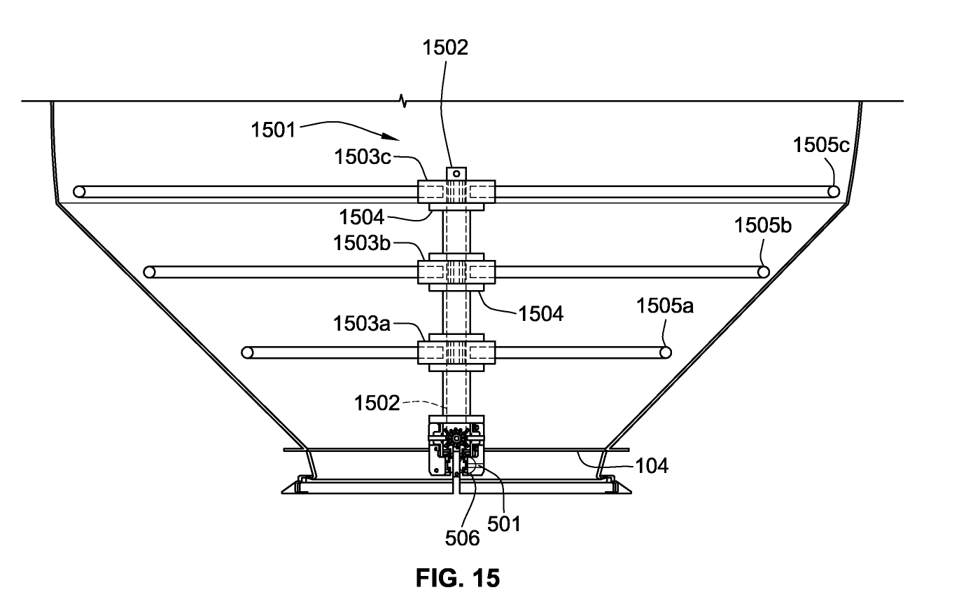

An example of this embodiment of the “one-agitator” system is illustrated in FIG. 15. The agitator 1501 comprises a rotating member 1502 that has a shaft having a square cross-section. This rotating member 1502 is inserted into a socket 501 (as shown in FIG. 5) in the same manner as the rotating member 512 of FIG. 5. The socket is rotationally driven by the axle 501 and gear 506 mechanism shown in FIG. 5.

Referring to FIG. 15, a plurality of hubs 1503a-c are fitted around the rotating member, which are vertically separated from each other by three retaining members 1504. Attached to each hub 1503a-c is a pair of spiral arms 1505a-c that extend in a plane perpendicular to the rotating member 1502. The spiral arms 1505a mounted to hub 1503a will have the shortest length, and the spiral arms 1505c mounted to hub 1503c will have the longest length, following the slope of the sloping walls. In the arrangement shown in this illustration, hub 1503a is set closest to the bottom outlet, and has spiral arms 1505a extending to a diameter that sweeps its horizontal space. Hub 1503b is set higher than hub 1503a, and has spiral arms 1505b that extend to a wider diameter than spiral arms 1505a, so as to sweep a wider horizontal space, following the slope of the hopper walls. Hub 1503c, in turn is set higher than hub 1503b, and likewise has attached spiral arms 1505b that extend to a wider diameter than spiral arms 1505b, again following the slope of the hopper walls. The diameters of the spiral arms 1505a-c, therefore, are selected to sweep the widening horizontal space as the slope sheets widen from the bottom outlet of the hopper.

Each of the hubs 1503a-c is separately mounted on the rotating member 1502. In this manner, each of the hubs 1503a-c is free to rotate with the rotating member 1502, except that each hub may slip on the rotating member due to each hub having a separate torque limiter (not shown in this drawing) associated with it. Thus, if one hub slips on the rotating member 1502 due to the resistance from the material load, the other hubs may still be able to rotate. In this manner, referring to FIG. 15, the lowest hub 1503a may rotate its associated spiral arms 1505a when the rotating shaft is turned, thereby driving the spiral arms 1505a in a horizontal plane near the hopper outlet. These spiral arms 1505a near the outlet serve to clear the horizontal area that is swept by the arms 1505a near the outlet of the hopper material. Generally, the lowest hub 1503a will experience the least resistance due to its shorter spiral arms 1505a. The lowest spiral arms 1505a will be able to clear out the material in their horizontal plane, even if the middle and upper hubs 1503b and 1503c are not able to move because of the caked material restricting motion of the spiral arms 1505b and 1505c, because the separate torque limiters 1506b and 1506c allow the hubs 1503b and 1503c to slip on the rotating member 1502. DDG or other material will fall into that space left behind by the lowest spiral arms 1505a. Once the material falls into the space left behind by spiral arms 1505a, the middle hub 1503b and subsequently upper hub 1503c will encounter less countervailing torque from the caked material, and will be able to rotate and clear the horizontal spaces around spiral arms 1505b and 1505c. Once the highest spiral arms 1505c have cleared their horizontal space, a cavity is created that is sufficiently large that the caked material above forms a “bridge” too large to sustain its own weight and therefore collapses, resulting in the release of the entire caked material load above the highest spiral arms 1505c.

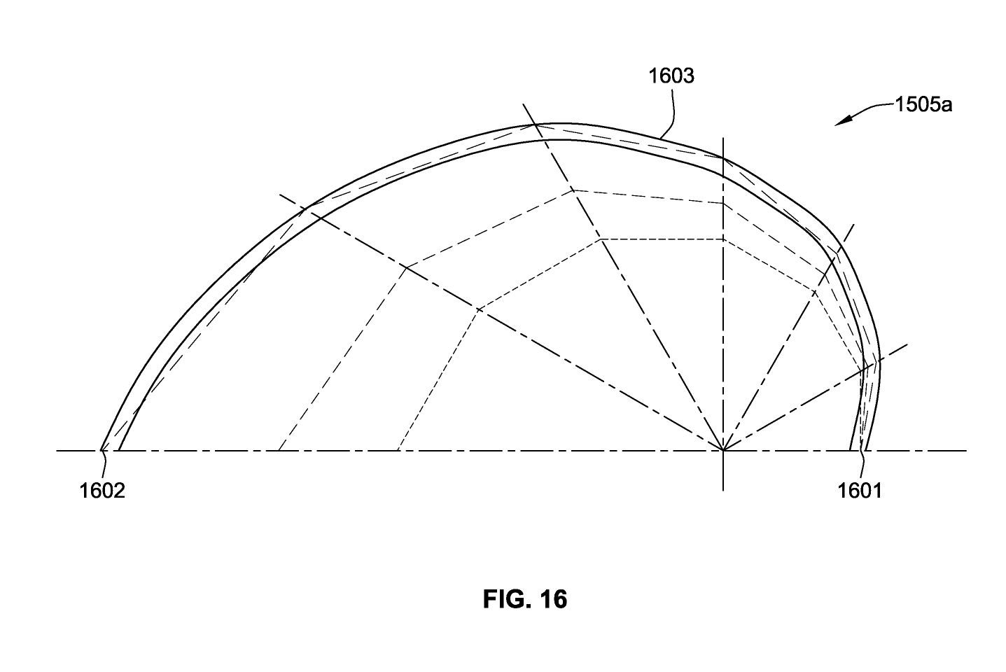

FIG. 16 illustrates a spiral arm 1505a. Spiral arms 1505b and 1505c are similar, except scaled up in size. The spiral arm 1505a extends spirally in a horizontal plane from the mounting point 1601, where it is mounted to its respective hub 1503a, through a spiral portion 1603 to a distal point 1602 which will be positioned near the sloping walls of the hopper outlet. The spiral arm 1505a may be mounted such that the arm will rotate around the hub with the distal point 1602 trailing the spiral portion 1603 of the spiral arm 1505a. In this illustration, the arm 1505a travels clockwise around the mounting point 1601 when the hub 1503a rotates in the plane of the spiral arm, so that the distal end 1602 trails the spiral portion 1603.

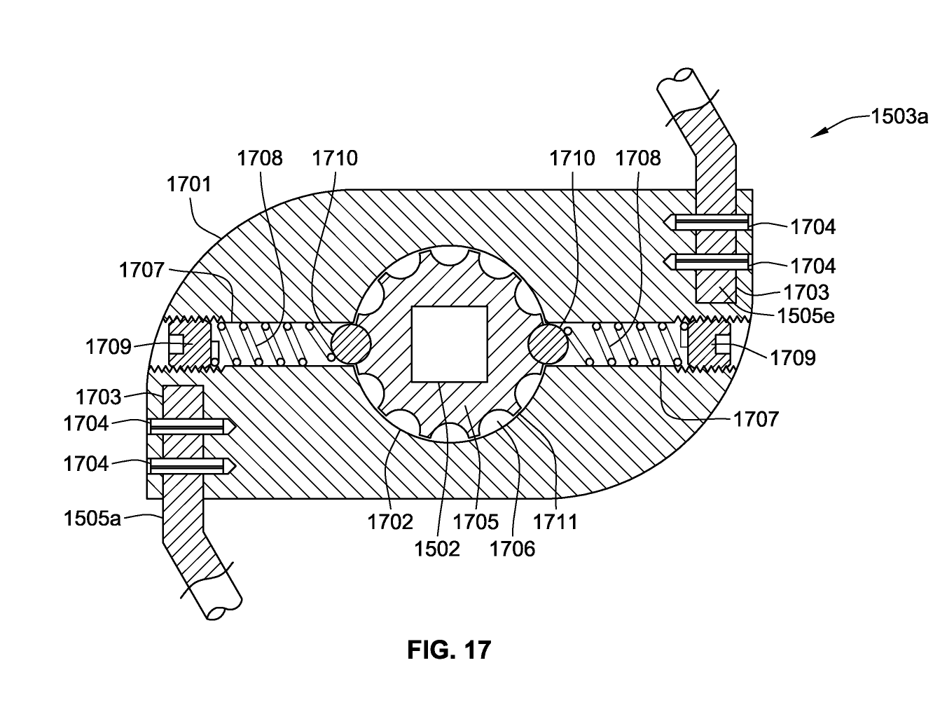

An example of a hub 1503a with spiral arms 1505a and torque limiter 1504a is illustrated in FIG. 17. The hub 1503a comprises a hub body 1701. The hub body 1701 is an oblong rectangular disc with rounded edges in the direction of rotation (in this illustration, counterclockwise), and has an aperture 1702 in its center. At either end of the hub body 1701, a spiral arm 1505a is mounted in a receptacle 1703 at the spiral arm's mounting point 1602. The two spiral arms are mounted at either end of the hub body 1701, and extend in opposing directions in the horizontal plane of the hub body 1701. The hub body 1701 and spiral arms 1505 are bored so that the roll pins 1704 may be inserted into the spiral arms to maintain their position and horizontal orientation in the hub body 1701.

In the embodiment shown in FIG. 17, the hub 1503a employs a ball detent torque limiter to engage the rotating member 1502, although other slip mechanisms can be incorporated. In this embodiment, a fluted rotor 1705 is disposed in the aperture 1702 and mounted around the rotating member 1502. The fluted rotor 1705 has a series of depressions 1706 and tabs 1711 that separate each depression 1706. The hub body 1701 also has two spring channels 1707 drilled from aperture 1702 through the plane of hub body 1701, opening to the outside of hub body 1701. Each of these channels contains a spring 1708 that is held in the channel by an adjustable plunging screw 1709. Each channel 1707 contains a ball 1710 that rests partly in the channel, and partly within one of the depressions 1706 of fluted rotor 1705. Each ball is maintained in place by force from spring 1708. The force of the spring 1708 is determined by the position of the plunging screw 1709 in channel 1707.

In the absence of any countervailing torque, rotating the rotating member 1502 will cause the fluted rotor 1705 to rotate the hub body 1701 through the balls 1710 which link the fluted rotor 1705 to the hub body 1701. The spiral arms, therefore, will rotate freely with the rotating member 1502.

However, if there is sufficient torque arising from the resistance of the material load to rotation, the tabs 1711 of the fluted rotor 1705 will overcome the force of springs 1708 and will push the balls 1710 through tabs 1711 into the channel 1707, allowing the fluted rotor 1705 to rotate free of the hub body 1701. This repeated action by the tabs 1711 of fluted rotor 1705 will cause the fluted rotor to slip against the hub body 1701, so as to disengage the hub body 1701 and spiral arms 1503a from the rotating member 1502. Thus, the point at which the resistance to the spiral arm torque causes the hub to slip and disengage the rotor is determined by the degree to which the plunging screw 1709 is driven into channel 1707, and thus the force which the spring 1708 applies to the balls 1710. The plunging screw 1709 can be adjusted on installation, based on the nature of the expected hopper load.

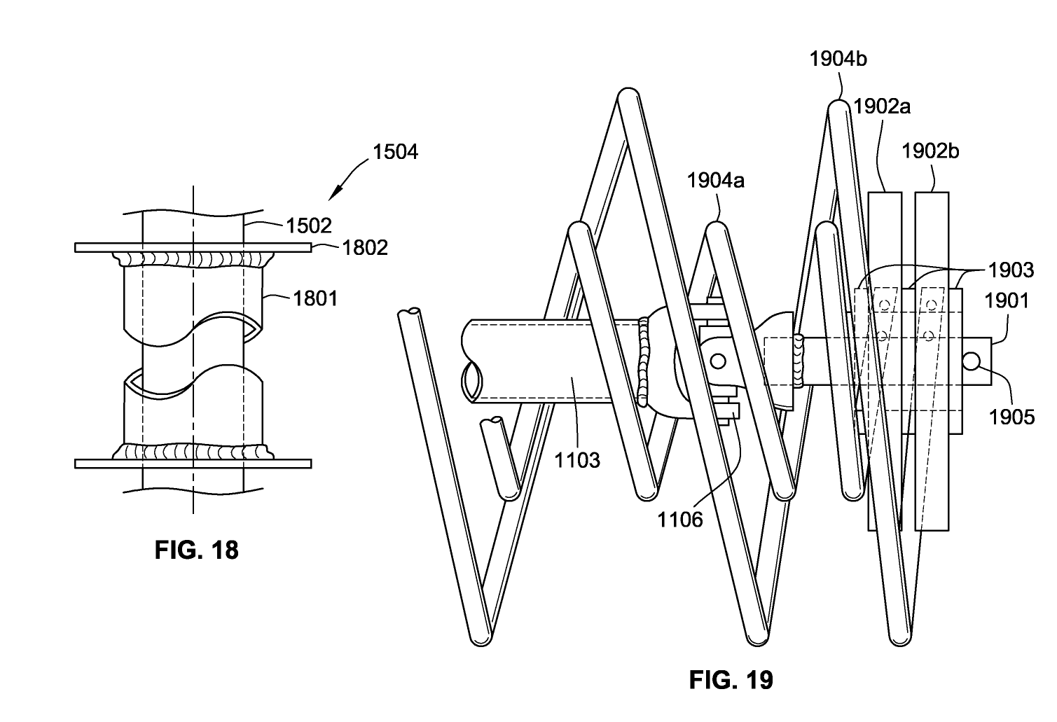

A retaining member 1504 is illustrated in FIG. 18. The retaining member 1504 comprises a pipe 1801 having sufficient inner diameter to accommodate and allow the rotation of the rotating member 1502 inside. The retaining member 1504 also has two flanges 1802 disposed around either end of pipe 1801. The flanges 1802 are wider than the apertures 1702 of the hubs (as shown in FIG. 17). When assembled, the flanges 1802 are in contact with the hubs 1503a (as shown in FIG. 15) and close off the hub aperture 1702. In this manner, the retaining members 1504 serve two purposes: to retain the balls 1710 in their respective hubs, as shown in FIG. 17, and to vertically separate the hubs 1503a-c from one another.

The principle of utilizing separate rotating augers that clear an ever-widening space, can also be applied to the four agitator device 1101, for example, the device shown in FIGS. 11-14. In this instance, instead of having one coil of uniform diameter extending along the rod 1103 of each agitator 502, each agitator 502 has two coils running the length of the rod 1103, one coil having a smaller coil diameter than the other, and both coupled to the rod 1103 through separate torque limiters.

An embodiment of the four-agitator aspect of the invention is shown in FIG. 19. A rod 1103 extending along each of the sloping valleys of the hopper is identical to the rod 1103 shown in FIG. 11 and associated drawings. The rod 1103 is also equipped with a universal joint 1106 at its end. The universal joint 1106 in this embodiment connects the rod to a rotating member 1901 that has a square shaft. Disposed around rotating member 1901 are two hubs 1902a and 1902b, which are attached respectively to small coil 1904a and large coil 1904b. The small coil 1904a has a smaller helical diameter than large coil 1904b. Both coils 1904a and 1904b are wound in the same helical direction, and wind around rod 1103. The hubs are separated by three retaining disks 1903 that are disposed around the rotating member 1901. The rotating member has a roll pin 1905 inserted at its distal end to maintain the position of the spacer disks 1903 and hubs 1902a and 1902b on the rotating member 1901.

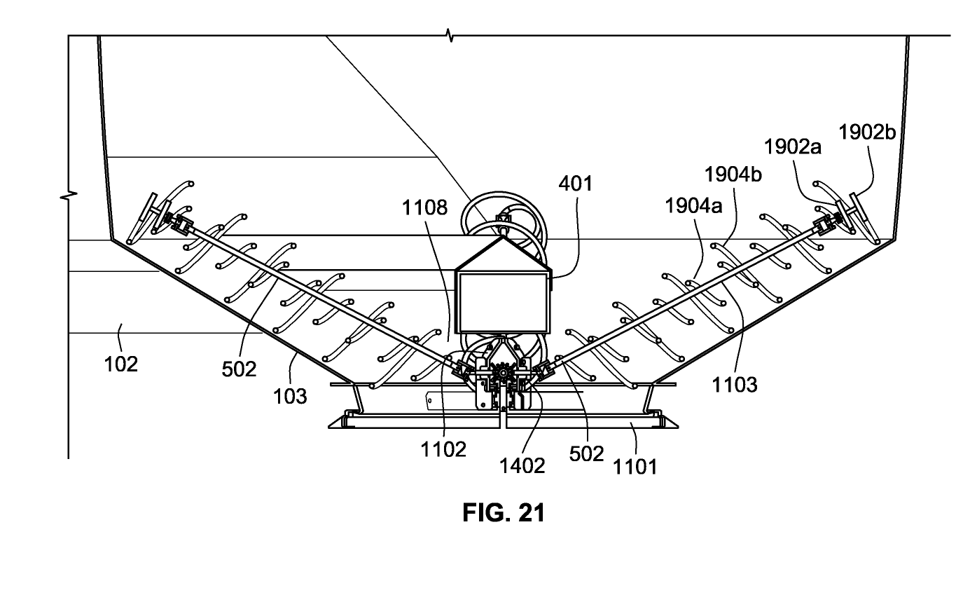

As seen in FIG. 21, both the small coil 1904a and the large coil 1904b extend from their respective hubs 1902a and 1902b to spiral around the length of the rod 1103 toward the central housing of the four-agitator system 1101, in a similar manner as the coils 1107 (as shown in FIG. 14), except in this embodiment the small coil 1904a rotates inside the large coil 1904b. The large diameter coil 1904b rests parallel to the sloping valleys of the hopper by virtue of gravity, because it is attached to the rod 1103 by a universal joint 1106. The large coil 1904b may extend the entire length of rod 1103, or may only extend over part of the rod. The small coil 1904a is attached at one end to its hub 1902a, and runs the entire length of the rod 1103. The end of small coil 1904a away from hub 1902a is supported by gravity by the rod 1103, as shown in FIG. 21. The small coil 1904a is supported by the rod 1103 so that the small coil 1904a is held within the diameter of large coil 1904b. In this manner, the rotation of coil 1904a does not interfere with the rotation of coil 1904b.

The two coil arms 1904a are rotatably attached to the rotating member 1901, subject to torque limiters contained in hubs 1902a and 1902b. Therefore, coil 1904a can rotate even if coil 1904b cannot rotate because to resistance from the load. The small coil 1904a, having a smaller diameter, will be able to rotate and clear the packed material in its vicinity. Once this happens, packed material in the vicinity of large coil 1904b will fall into the space that has been cleared by small coil 1904b, thereby facilitating the rotation of large coil 1904b, and the clearing of packed material in the vicinity of the large coil 1904b.

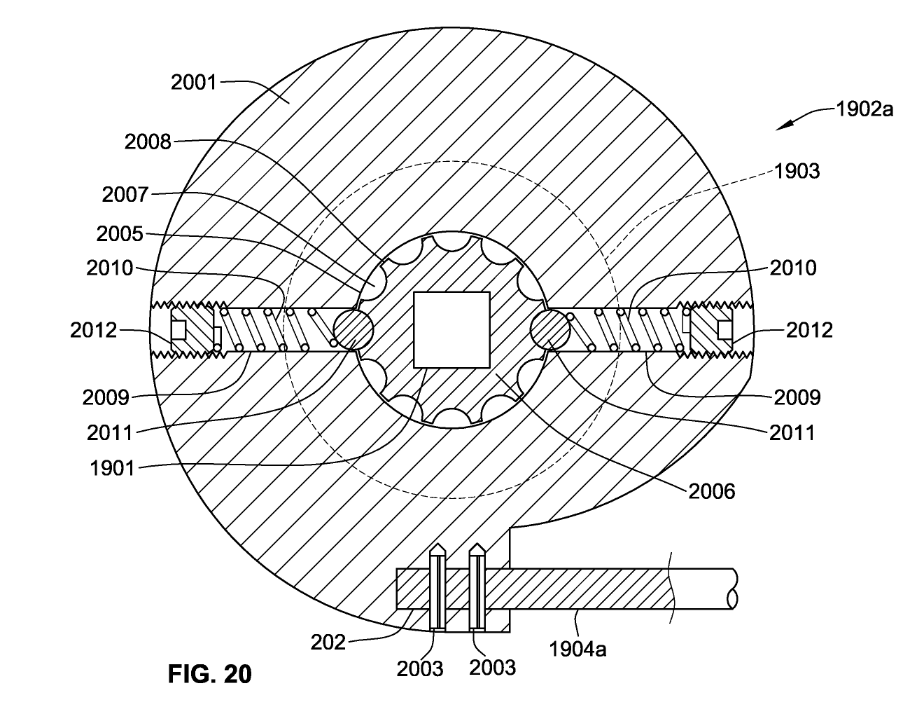

FIG. 20 shows a detail of hub 1902a with a ball detent torque limiter similar to that shown in FIG. 17. Hub 1902a has a hub body 2001, which is an essentially circular disk, having a cutout surface 2004 into which a bore 2002 is drilled. One end of coil 1902a is mounted into this bore 2002 and held in place with roll pins 2003 that are inserted through the hub body 2001 and coil 1904a. The hub body 2001 has a circular aperture 2005 in the center, in which is disposed a fluted rotor 2006 having depressions 2007 that are separated by tabs 2008. The fluted rotor is attached to and rotates with rotating member 1901. The hub body 2001 has two channels 2009 that are bored in the thickness of the disk from the aperture to the outer edge of the hub body 2001. Each of these channels accommodates a spring 2010, a ball 2011 that rests partly in one of the depressions 2007 of fluted rotor 2006, and a plunger screw 2012. It should be noted that retaining disks 1903 are fitted around the rotating member 1901, and have an outer diameter greater than the aperture 2005, as indicated on FIG. 20. In this manner, the retaining disks 1903 keep the balls 2011 within their respective hub apertures 2005.

The hub 1902a (and similarly, hub 1902b) works in a manner similar to the hub shown in FIG. 17. As the rotating member 1901 is rotated through the mechanisms described in FIG. 11, the fluted rotor 2006 rotates in the hub, pushing the balls 2011 and thereby rotating the hub body 2001 and its associated coil 1904a. If there is sufficient torque on the coil due to the resistance of caked material, the hub body 2001 will slip against fluted rotor 2006 by pushing the balls 2011 into channels 2009. The torque required for the hub body 2001 to slip is determined by the extent to which plunger screws 2012 are driven into the channels 2008. This adjustment of the plunger screws 2012 can be set on installation, depending on the nature of the material load. Typically, the plunger screws will be set to obtain a torque release value not exceeding the maximum torque sustained by the widest diameter agitator, and such that the torque sustained by the agitators does not damage the gear linkage to the driving axle.

While various embodiments have been described, it will be apparent to those of ordinary skill in the art that many more embodiments and implementations are possible within the scope of the invention. Accordingly, the invention is not to be restricted except in light of the attached claims and their equivalents.

What is claimed is:

1. A device for assisting bulk material to flow from a hopper having a bottom outlet, said device comprising:
a rotatable axle; and
one or more rotatable agitators, each rotatably connected to the axle, and disposed inside the hopper near the bottom outlet;
wherein rotating the axle causes each agitator to rotate, thereby breaking up and urging bulk material to flow downward through the bottom outlet.

2. The device of claim 1, wherein each agitator has an axis of rotation different from the axle.

3. The device of claim 1, wherein the axle is a horizontal axle, and wherein the axle has one coupling at an end that is capable of being rotatably attached to a drive bit of a power wrench so that the axle may be rotated by the power wrench.

4. The device of claim 3, wherein the coupling allows the power wrench to rotate the axle in only one desired direction.

5. The device of claim 4, wherein the coupling may be rotated by a drive bit having four corners, and wherein said coupling comprises:
an inner wheel attached at one end of the axle;
an outer wheel parallel to the inner wheel and attached to the inner wheel by four posts that extend between the inner and outer wheel;
four spring-biased rotation stops each mounted on one of the posts; and
an access corridor comprising a circular opening in the inner wheel and a circular opening in the outer wheel, and which is capable of accommodating the drive bit,
wherein the posts are arranged at ninety degrees to one another on the perimeter of the access corridor,
wherein the rotation stops are arranged so as to be automatically displaced from engagement with the drive bit when the drive bit is rotated in the direction opposite the desired direction, so that the drive bit rotates freely but does not rotate the coupling and axle, and
wherein the rotation stops are arranged so that when the drive bit is inserted into the access corridor and rotated in the desired direction, the corners of the drive bit engage the rotation stops which are spring-biased to be in a position to so engage, and the rotation stops restrain the drive from rotating freely unless the coupling and axle also rotate.

6. The device of claim 1, wherein the axle is rotatably connected to an axle gear, and further comprising a agitator gear rotatably connected to the axle gear, wherein each of the one or more agitators is connected to the axle by a connection comprising the agitator gear and the axle gear.

7. The device of claim 6, wherein the connection comprises
a central socket rotatably connected to the agitator gear,
a rotating member disposed in the central socket and rotating in the same axis as the agitator gear, wherein said rotating member drives the rotation of the one or more agitators.

8. The device of claim 7, having only one agitator, and wherein the rotating member is directly attached to the agitator, so that the agitator rotates in the same axis as the agitator gear.

9. The device of claim 7, having more than one agitator, and further comprising
a central gear rotatably connected with the rotating member; and
two or more peripheral gears each enmeshed with the central gear, wherein each peripheral gear is rotatably coupled with an agitator.

10. The device of claim 9, wherein each agitator has an axis of rotation approximately parallel with a sloping valley of the hopper.

11. The device of claim 10, wherein each agitator comprises a helical coil, and wherein said helical coil is disposed along a sloping valley of the hopper.

12. The device of claim 11, wherein each agitator comprises
a rod;
a proximal universal joint connected to a proximal end of the rod;
a distal universal joint that is connected to a distal end of the rod; and
a helical coil with two ends, wherein one end of the coil is connected to the rod by the distal universal joint,
wherein the rod is rotatably connected to the axle by a connection that comprises the proximal universal joint.

13. The device of claim 12, wherein each agitator comprises
a rod;
a proximal universal joint connected to a proximal end of the rod;
a distal universal joint that is connected to a distal end of the rod;
a rotating member connected to the distal universal joint;
two or more hubs mounted on the rotating member, wherein each hub supports one end of a helical coil, and each helical coil extends along the sloping valley of a hopper.

14. The device of claim 13, wherein the helical coil of each hub associated with an agitator has a different helical diameter.

15. The device of claim 13, wherein each hub further comprises a torque limiter attaching the hub to the rotating member.

16. The device of claim 15, wherein each torque limiter is settable to a different torque release value.

17. The device of claim 1, wherein the bulk material is distiller's dry grains, and the hopper is a railway car hopper.

18. The device of claim 1, wherein each agitator comprises a helical coil having a helical axis.

19. The device of claim 18, wherein the helical coil when viewed along its helical axis has a conical, cylindrical, or balloon shape.

20. The device of claim 1, wherein each agitator comprises:
a rotating member; and
two or more hubs rotatably connected to the rotating member,
wherein each hub comprises one or more arms, and each hub has a torque limiter that rotatably connects each hub to the rotating member.

21. The device of claim 20, wherein each arm extends in a spiral fashion from its respective hub.

22. The device of claim 20, wherein the torque limiter is a ball detent torque limiter.

23. The device of claim 29, wherein the hubs are vertically separated, and each hub has a set of auger arms of a different diameter.

24. A system for removing bulk material from a hopper having a bottom outlet, comprising:
the device for assisting bulk material to flow from a hopper according to claim 1;
a gate assembly that may be secured to the bottom outlet, comprising a gate that is capable of opening and closing the bottom;
wherein when the gate assembly is secured to the bottom outlet and the gate is opened, and the axle rotates the agitators, the agitators break up and urge bulk material to flow downward and out of the bottom outlet of the hopper.

25. The system of claim 24, wherein the gate assembly comprises a frame, said frame comprising an upper flange that is attachable to an outlet flange of the bottom outlet of the hopper, and side panels extending downward from the flange when attached to the hopper.

26. The system of claim 24, wherein the gate assembly further comprises a housing that supports the rotation of the one or more agitators, and a beam that attaches the housing to the frame.
